(19) United States
(12) Patent Application Publication
(10) Pub. No.: US 2011/0176703 A1
(43) Pub. Date: Jul. 21, 2011

(54) SPEAKER DEVICE

(75) Inventors: Minoru Horigome, Yamagata (JP); Hiroyuki Kobayashi, Yamagata (JP); Shunichi Takahashi, Yamagata (JP); Yasuhisa Abe, Yamagata (JP); Yasuhiro Saso, Yamagata (JP); Toshihiro Hikichi, Yamagata (JP); Takuei Nagasawa, Yamagata (JP); Tempei Katsuta, Tokyo (JP)

(73) Assignees: PIONEER CORPORATION, Tokyo (JP); TOHOKU PIONEER CORPORATION, Tendo-shi, Yamagata (JP)

(21) Appl. No.: 12/921,715

(22) PCT Filed: Jul. 29, 2009
(86) PCT No.: PCT/JP2009/063525

§ 371 Date: Sep. 9, 2010

(51) Int. Cl. H04R 9/06

(52) U.S. Cl. 381/412

(57) ABSTRACT

A speaker device includes a speaker unit and a cabinet on or in which the speaker unit is mounted. The speaker unit includes a diaphragm, a static part supporting the diaphragm vibratably in a vibration direction, and a driving part provided at the static part to vibrate the diaphragm in response to an audio signal. The driving part includes a magnetic circuit forming a magnetic gap, a voice coil vibrating in a direction different from the vibration direction of the diaphragm upon the inputted audio signal, and a rigid vibration direction converter part configured to convert the vibration direction of the voice coil and transmit the vibration to the diaphragm.

### FIELD OF THE INVENTION

The present invention relates to a speaker device.

### BACKGROUND OF THE INVENTION

A dynamic speaker device is known as a typical speaker device (for example, see patent literature 1). The dynamic speaker device, for example, as shown in FIG. 1, includes a frame 3J, a cone-shaped diaphragm 21J, an edge 4J through which the diaphragm 21J is supported by the frame 3J, a voice coil bobbin 610J applied to the inner periphery part of the diaphragm 21J, a damper 7J through which the voice coil bobbin 610J is supported by the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by a Lorentz force developed in the voice coil 611J in the magnetic gap and the diaphragm 21J is driven by the vibration.

[Patent literature 1] Publication of unexamined patent application H8-149596 (FIG. 1)

### SUMMARY OF THE INVENTION

The typical dynamic type speaker device as described above is configured such that the voice coil 611J is disposed opposite to the sound emission side of the diaphragm 21J and the vibration directions of the voice coil 611J and the voice coil bobbin 610J are the same as the vibration direction of the diaphragm 21J, for example, as shown in FIG. 1. In the speaker device as configured above, a region for vibration of the diaphragm 21J, a region for vibration of the voice coil bobbin 610J, and a region for arranging the magnetic circuit, etc. are necessarily formed in the vibration direction (sound emission direction) of the diaphragm 21J. Accordingly, the total height of the speaker device necessarily becomes comparatively large.

Specifically, as shown in FIG. 1, the dimension of the above-mentioned speaker device in the vibration direction of the diaphragm 21J includes (a) the total height of the cone-shaped diaphragm 21J in the vibration direction and the edge 4J through which the diaphragm 21J is supported by the frame 3J, (b) the height of the voice coil bobbin from the joining part of the diaphragm 21J and the voice coil bobbin 610J to the upper end of the voice coil 611J, (c) the total height of the voice coil, (d) the height mainly of the magnet of the magnetic circuit, corresponding to the height from the lower end of the voice coil 611J to the upper end of the yoke 51J, (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to secure a sufficient electromagnetic force. Accordingly, particularly in a speaker device adapted to a large sound volume, the total height of the speaker device inevitably becomes large.

Since the vibration direction of the voice coil bobbin 610J is the same as that of the diaphragm 21J in the conventional speaker device as described above, the total height of the speaker device inevitably becomes large to secure a vibration stroke of the voice coil bobbin 610J, when seeking a large volume sound with large amplitude of vibration of the diaphragm 21J. Thus, it becomes difficult to make a thin device. In other words, the problem is that making a thin device and securing a loud sound are contradictory to each other.

Further, in the conventional speaker device, when a speaker unit is arranged in the cabinet, it is required to provide a large depth of the cabinet on the rear side of the speaker unit corresponding to total height of the speaker unit, when securing a sufficient space volume on the rear side of the speaker unit. As such, the speaker device as a whole including the cabinet becomes large, and thereby there is a problem of limiting installation space for the speaker device. In particular, the installation space for the speaker device is limited specifically in an in-car speaker, etc., and thereby there is a problem that the speaker unit may not be arranged in the cabinet having a sufficient volume.

It is an object of the present invention to overcome the problem described above. That is, an object of the present invention is to provide a thin speaker device capable of emitting a reproduced sound at large volume, a thin speaker device capable of efficiently transmitting the vibration of the voice coil to the diaphragm by converting a direction of a vibration produced by the voice coil, enabling the whole speaker device including the cabinet to be thin, while providing preferable acoustic performance of the speaker unit by securing a sufficient volume in the cabinet, etc.

A speaker device according to the present invention has at least a configuration according to the following:

A speaker device includes a speaker unit and a cabinet on or in which the speaker unit is mounted. The speaker unit includes a diaphragm, a static part supporting the diaphragm vibratably in a vibration direction, and a driving part provided at the static part to vibrate the diaphragm in response to an audio signal. The driving part includes a magnetic circuit forming a magnetic gap, a voice coil vibrating in a direction different from the vibration direction of the diaphragm upon the inputted audio signal, and a rigid vibration direction converter part configured to convert the vibration direction of the voice coil and transmit the vibration to the diaphragm. The rigid vibration direction converter part is arranged such that one end is angle-variably coupled to the voice coil while another end is angle-variably coupled to the diaphragm, the vibration direction converter part being obliquely disposed with respect to the vibration direction of the diaphragm and the vibration direction of the voice coil respectively, and the cabinet is configured to form a prescribed space between the cabinet and the speaker unit.

A speaker device includes a speaker unit and a cabinet on or in which the speaker unit is mounted. The speaker unit includes a diaphragm, a static part supporting the diaphragm vibratably in a vibration direction, and a driving part provided at the static part to vibrate the diaphragm in response to an audio signal. The driving part includes a magnetic circuit forming a magnetic gap in a direction different from the vibration direction of the diaphragm, a voice coil vibrating along the magnetic gap, and a vibration direction converter part configured to convert a vibration direction of the voice coil and transmit the vibration to the diaphragm. The vibration direction converter part includes a link body configured to angle convert a link part formed between the voice coil and the diaphragm, and the cabinet is configured to form a prescribed space between the cabinet and the speaker unit.

### BRIEF DESCRIPTION OF THE DRAWINGS

FIG. 1 is a view illustrating a speaker device of a prior art;

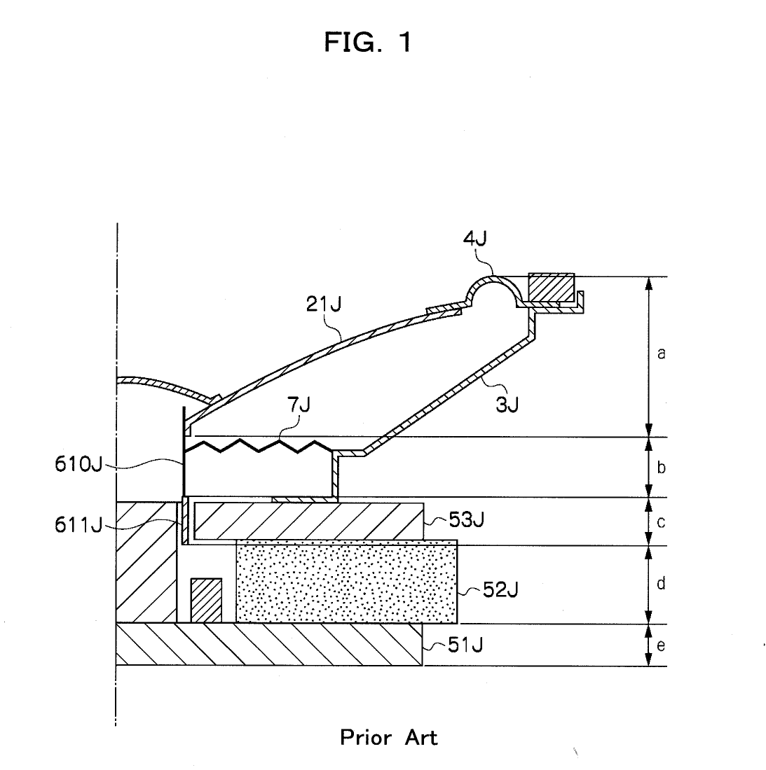

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part);

FIGS. 3(a)-(c) are views illustrating a configuration example and an operation of a vibration direction converter part;

FIGS. 4(a)-(c) are views illustrating a configuration example and an operation of the vibration direction converter part;

FIG. 5 is a view illustrating a formation example of the vibration direction converter part (FIG. 5(a) is a side view, FIG. 5(b) is a perspective view and FIG. 5(c) is an enlarged view of part A);

FIGS. 6(a)-(c) are views illustrating a formation example of the vibration direction converter part;

FIG. 7 is a view illustrating a speaker device adopting the vibration direction converter part (FIG. 7(a) is a cross-sectional view taken along X-axis direction and FIG. 7(b) is a view illustrating an operation of the driving part);

FIG. 8 is a view illustrating a speaker device adopting the vibration direction converter part (FIG. 8(a) is a cross-sectional view taken along X-axis direction and FIG. 8(b) is a view illustrating an operation of the driving part);

FIGS. 9(a) and (b) are views illustrating a specific vibration direction converter part;

FIGS. 10(a) and (b) are views illustrating a specific vibration direction converter part;

FIGS. 11(a) and (b) are views illustrating another example of the vibration direction converter part;

FIG. 12 is a view illustrating another example of the vibration direction converter part;

FIGS. 13(a)-(c) are views illustrating another example of the vibration direction converter part;

FIGS. 14(a) and (b) are views illustrating another example of the vibration direction converter part;

FIGS. 15(a) and (b) are views illustrating a power feed structure of the speaker unit according to an embodiment of the present invention;

FIG. 16 is a view illustrating a power feed structure of the speaker unit according to an embodiment of the present invention;

FIG. 17 is a view illustrating a power feed structure of the speaker unit according to an embodiment of the present invention;

FIG. 18 is a view illustrating a power feed structure of the speaker unit according to an embodiment of the present invention;

FIG. 19 is a view illustrating a power feed structure of the speaker unit according to an embodiment of the present invention;

FIG. 20 is a view illustrating a power feed structure of the speaker unit according to an embodiment of the present invention;

FIG. 21 is a view illustrating an attachment structure of a voice coil of the speaker unit according to an embodiment of the present invention;

FIGS. 22(a)-(c) are views illustrating a power feed structure of the speaker unit according to an embodiment of the present invention;

FIGS. 23(a)-(e) are views illustrating a configuration example of a cabinet applied to the speaker device according to an embodiment of the present invention;

FIGS. 24(a)-(c) are views illustrating a configuration example of a cabinet applied to the speaker device according to an embodiment of the present invention;

FIGS. 25(a) and (b) are views illustrating a configuration example of a cabinet applied to the speaker device according to an embodiment of the present invention;

FIG. 26 is a view illustrating an example of a speaker unit arrangement in a cabinet of the speaker device according to an embodiment of the present invention;

FIGS. 27(a) and (b) are views illustrating an example of a speaker unit arrangement in a cabinet of the speaker device according to an embodiment of the present invention;

FIGS. 28(a)-(c) are views illustrating an example of a speaker unit arrangement in a cabinet of the speaker device according to an embodiment of the present invention;

FIG. 29 is a view illustrating an example of a speaker unit arrangement in a cabinet of the speaker device according to an embodiment of the present invention;

FIGS. 30(a)-(c) are views illustrating an example of a speaker unit arrangement in a cabinet of the speaker device according to an embodiment of the present invention;

FIG. 31 is a view illustrating an example of a speaker device 1 including a cabinet in the speaker device according to an embodiment of the present invention;

FIG. 32 is a cross-sectional perspective view illustrating a whole configuration of the speaker device according to an embodiment of the present invention;

FIGS. 33(a) and (b) are views illustrating an on-board example of the speaker device according to an embodiment of the present invention; and

FIG. 34 is a view illustrating an on-board example of the speaker device according to an embodiment of the present invention.

### DETAILED DESCRIPTION OF THE INVENTION

Hereinafter, an embodiment according to the present invention is described with reference to the drawings. The embodiment according to the present invention includes what is shown in the drawings, but is not limited to this alone. In the description hereinafter, the same symbol is applied to the same part as the part that has already been described, and thus a part of the same description may not be repeated.

### [Whole Structure of Speaker Device]

A speaker device according to an embodiment of the present invention includes a speaker unit and a cabinet on or in which the speaker unit is mounted. And, the cabinet has a prescribed space between the cabinet and the speaker unit.

The speaker unit, which is described hereinafter, includes a diaphragm, a static part supporting the diaphragm vibratably in the vibration direction and a driving part provided at the static part to vibrate the diaphragm in response to an audio signal. The driving part includes a magnetic circuit forming a magnetic gap, a voice coil vibrating in a direction different from the vibration direction of the diaphragm upon the inputted audio signal and a rigid vibration direction converter part configured to convert the direction of the vibration of the voice coil and transmit the vibration to the diaphragm. The vibration direction converter part is arranged such that one end is angle-variably coupled to the voice coil directly or via other member, while another end is angle-variably coupled to the diaphragm directly or via other member, the vibration direction converter part being obliquely disposed with respect to the vibration direction of the diaphragm and the vibration direction of the voice coil respectively.

Further, the speaker unit includes a diaphragm, a static part supporting the diaphragm vibratably in the vibration direction and a driving part provided on the static part to vibrate the diaphragm in response to an audio signal. The driving part includes a magnetic circuit forming a magnetic gap in a direction different from the vibration direction of the diaphragm, a voice coil vibrating along the magnetic gap and a vibration direction converter part configured to convert the direction of the vibration of the voice coil and transmit the vibration to the diaphragm. The vibration direction converter part includes a link body configured to angle convert a link part that is formed between the voice coil and the diaphragm.

In the speaker device that includes a configuration described above a large amplitude of vibration of the voice coil in the speaker unit] has little direct effect on the thickness of the speaker unit in sound emission direction, since vibration direction converter part converts the direction of the vibration produced by the voice coil and transmits the vibration to the diaphragm. Therefore, it is possible to make the speaker unit thin while achieving the speaker unit making a louder sound. The cabinet, at which the speaker unit described above is placed, may be configured to have a large volume in a space between the cabinet and the speaker unit even when the speaker unit is housed in the cabinet having a small depth, since the speaker unit may be made thin. As such, the whole speaker device including the cabinet may be made thin, and thus an improved installation space for the speaker device may be secured. In addition, the speaker unit may provide a preferable acoustic performance with a space having a sufficient volume, which is made on the rear side of the speaker unit in the cabinet. If a space volume in the cabinet is small, air in the cabinet, which is subject to repeated contraction and expansion, acts as a spring preventing vibration of the diaphragm, thereby degrading acoustic performance. However, in the embodiment according to the present invention, it is possible to restrain such degradation of acoustic performance by securing a sufficient space volume in the cabinet even if the cabinet has a short depth.

### [Speaker Unit]

### (Basic Configuration)

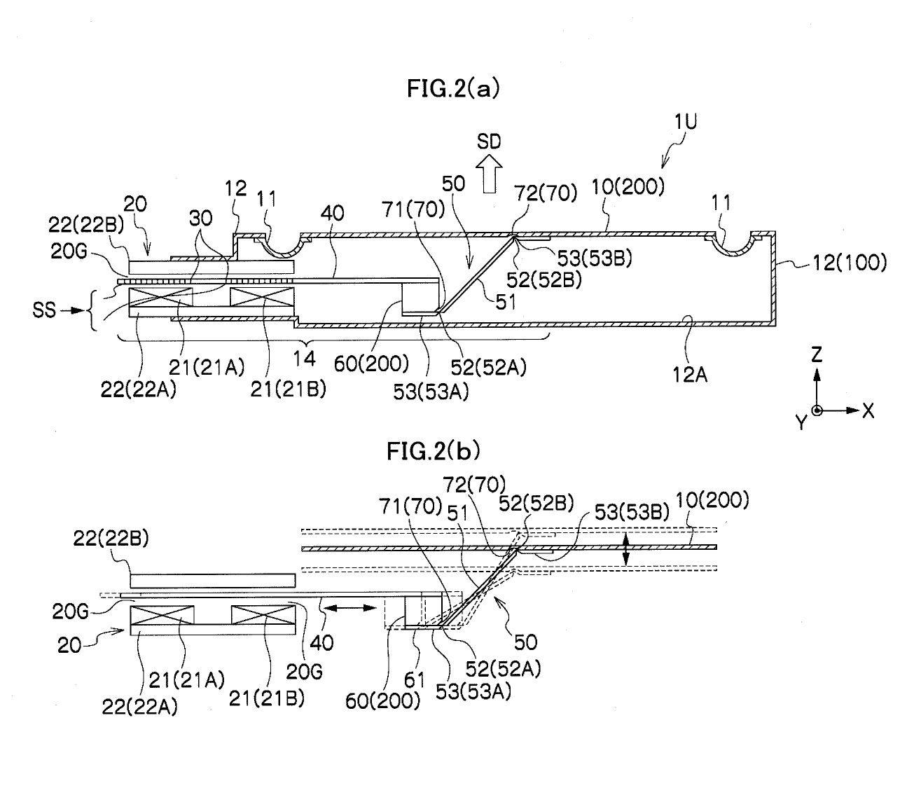

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part). The speaker unit 1U includes a diaphragm 10, a static part 100 supporting the diaphragm 10 vibratably in the vibration direction and a driving part 14 arranged at the static part 100 to vibrate the diaphragm 10 in response to an audio signal. The driving part 14 includes a magnetic circuit 20 forming a magnetic gap 20G, a voice coil 30 vibrating in a direction different from the vibration direction of the diaphragm 10 upon the inputted audio signal and a vibration direction converter part 50 to convert the direction of the vibration produced by the voice coil 30 and transmit the vibration to the diaphragm 10. The voice coil 30 itself may connect with the vibration direction converter part 50, while the voice coil 30 is supported by a voice coil support part 40 as shown in the drawings. In this embodiment, the vibration direction of the voice coil 30 is X-axis direction and two directions orthogonal to X-axis direction are Y-axis direction and Z-axis direction respectively.

The diaphragm 10 may be formed substantially in a rectangular shape, a circular shape, an ellipsoidal shape or other shapes in the plan view. Further, the cross-sectional shape of the diaphragm 10 may be formed in a prescribed shape, for example, such as a tabular shape, a dome shape, a cone shape, etc. The cross-sectional shape of the diaphragm 10 is planar as shown in the drawings, however it may be formed in a curved shape. Further, the speaker unit 1U may be made thin by making the total height of the diaphragm 10 comparatively small as necessary.

The static part 100 is a collective term for those that support vibrations of the diaphragm 10, the driving part 14, etc., which includes the frame 12 and those that have also a function of the frame 12 such as an after-mentioned yoke, a mounting unit, etc. The static part 100 is, however, not necessarily completely static. The whole static part 100 may vibrate subject to vibration of the driving part 14 or other force. The outer periphery part of the diaphragm 10 is supported via an edge 11 by the frame 12 as the static part 100.

The driving part 14 has the magnetic circuit 20, the voice coil 30 and the vibration direction converter part 50. The voice coil 30 vibrates in one axis direction along the magnetic gap 20G of the magnetic circuit 20 and the vibration direction converter part 50 converts the direction of the vibration and transmits the vibration to the diaphragm 10. The voice coil 30 vibrates in X-axis direction and the diaphragm 10 is vibratably arranged in Z-axis direction orthogonal to X-axis direction as shown in the drawings. The vibration direction converter part 50 converts the vibration of the voice coil 30 in X-axis direction into a vibration at obliquely disposed angle of its own displacement, and thus vibrating the diaphragm 10 in Z-axis direction.

The magnetic circuit 20 has a magnet 21 (21A, 21B) and a magnetic pole member (yoke) 22 (22A, 22B) such that a plurality of the magnetic gaps 20G are arranged in vibration direction of the voice coil 30, for example, in X-axis direction. In this embodiment, the magnetic pole direction of the magnet 21 (21A, 21B) is set such that magnetic field directions of a pair of the magnetic gaps 20G are opposite to each other (±Z-axis direction). The voice coil 30 made up of a wound conducting member is arranged such that currents flow in directions opposite to each other (±Y-axis direction) in the magnetic gap 20G having magnetic fields in directions opposite to each other. Thereby, a driving force (Lorentz force, electromagnetic force) may be developed in the voice coil 30 in directions (±X-axis directions) along the magnetic gap 200. Relationship of arrangement between the magnet 21 and the magnetic pole member (yoke) 22 is not limited to the example shown in the drawings. Rigidity (bending rigidity, torsional rigidity included) may be added to the voice coil 30 as a whole by forming the voice coil support part 40 with, for example, a tabular insulating member.

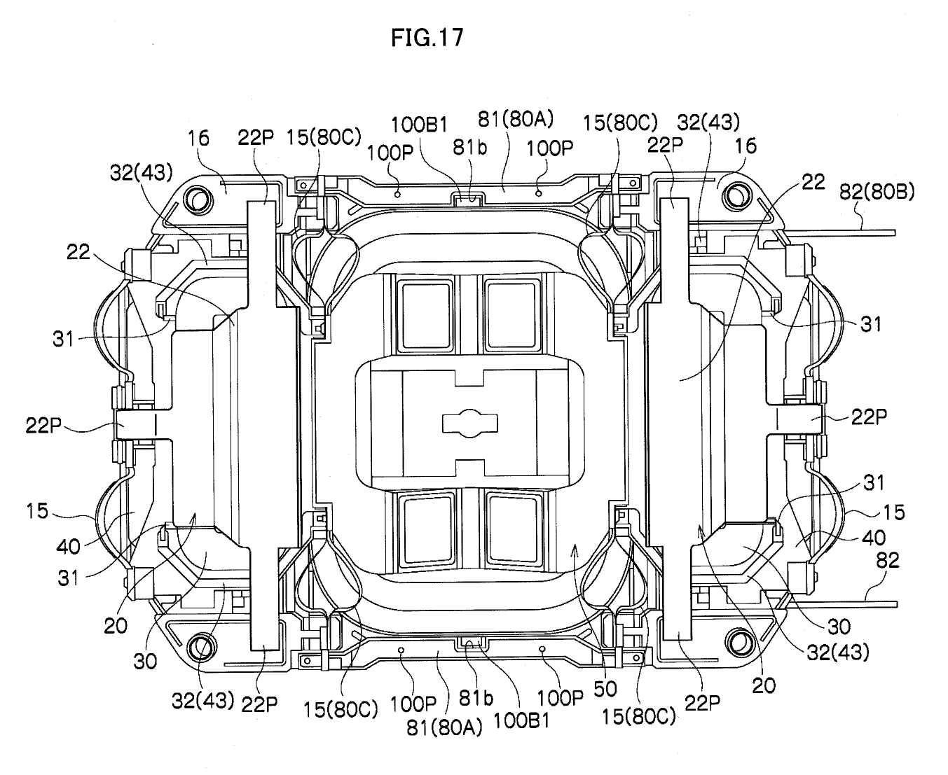

A tabular insulating member as the voice coil support part 40 has a plurality of conducting layers formed at the outside of a conducting wire. The conducting layer 43 is electrically connected to a lead wire 31 (see FIG. 17) that is pulled out from the start point and the end point of the conducting wire. The lead wire 31 is configured, for example, with a part of an after-mentioned conducting member. Further, the lead wire 31 is electrically connected to outside via an after-mentioned holding part 15, thus functioning as a junction wire for inputting an outside audio signal into the voice coil 30. Further, for example, when a conducting wire free from the voice coil is wound in the speaker unit as the junction wire, an additional space for wiring by winding is required. However, since the conducting layer 43 (see FIG. 17) as the junction wire is formed on the surface of the voice coil support part 40, the space for the junction wire is no longer required, and thus the speaker unit may be made thin. As shown in the drawings, the voice coil 30 and the voice coil support part 40 are formed to be tabular, but they are not limited to this form and may be formed to be tubular. Further if the voice coil 30 or the voice coil support part 40 supporting the voice coil 30 are formed to be tubular, a tabular lid, which enables angle-variable coupling of the vibration direction converter part, may be connected with the end of the vibration direction converter part 50.

The voice coil 30 is formed by winding the conducting wire (conducting member) to which the audio signal is inputted. The voice coil 30 in itself is vibratably arranged at the static part 100 or is vibratably arranged at the static part 100 via the voice coil support part 40. The voice coil support part 40 may be formed, for example, with a tabular insulating member, and the voice coil 30 is supported on the surface of or inside the voice coil support part 40.

Since the voice coil support part 40 is formed, for example, with the tabular insulating member, rigidity (bending rigidity and torsional rigidity included) may be added to the voice coil 30 as a whole.

The voice coil 30 is held on the static part 100 with a holding part not shown in the drawings. The holding part is configured to vibratably hold the voice coil 30 or the voice coil support part 40 in vibration direction (for example, X-axis direction) with respect to the static part 100 and restrict them not to move in other directions. For example, the holding part is deformable in the vibration direction (for example, X-axis direction) of the voice coil 30. And the holding part may be formed with a curved plate member having rigidity in a direction crossing this vibration direction. Further, the length of the voice coil 30 in the direction orthogonal to the vibration direction of the voice coil thereof may be comparatively long with respect to the length of the voice coil 30 in the vibration direction of the voice coil so that a comparatively large driving force may be produced when driving a speaker.

The vibration direction converter part 50 has one end angle-variably connected to the voice coil 30 directly or via other member, and has another end angle-variably connected to the diaphragm 10 directly or via other member. The vibration direction converter part 50 is obliquely disposed with respect to each of vibration directions of the diaphragm 10 and the voice coil 30. Specifically, the vibration direction converter part 50 includes a rigid link part 51 angle-variably and obliquely disposed between the voice coil 30 or the voice coil support part 40 and the diaphragm 10, and a hinge part 52, which is formed at both ends of the link part 51 and functions as a fulcrum for angle change of the vibration direction converter part 50. The connecting part 53 of the vibration direction converter part 50 is connected to the diaphragm 10, the voice coil 30, or an attaching counterpart 200 including other member than the diaphragm 10 or the voice coil 30 with a coupling member including a joining member such as an adhesive or a double-faced tape, and a fastener member such as a screw, etc. The hinge part 52 is arranged in proximity of the attaching counterpart 200. The connecting part 53 (53A) at the end of the vibration direction converter part 50 is coupled to the voice coil 30 or the voice coil support part 40 via a connecting part 60 as shown in the drawings. However, the connecting part 53 (53A) may be directly connected without the connecting part 60. The connecting part 60 is formed between the end of the vibration direction converter part 50 on the voice coil side and the end of the voice coil 30 or the voice coil support part 40 on the side of vibration direction converter part, and thereby both ends are coupled spaced apart in the vibration direction. Further, the connecting part 60 absorbs the thickness of the magnetic circuit 20, thus making the speaker unit thin.

Further, a contact avoiding part 70 avoiding contact with the hinge part 52 is formed on the surface side of the attaching counterpart 200 in proximity of the hinge part 52 of the vibration direction converter part 50. The contact avoiding part 70 also functions as a joining member housing part (restraining part), which houses and restrains the joining member joining the vibration direction converter part 50 and the attaching counterpart 200. The contact avoiding part 70 is, for example, a concave portion, a notch part, a groove part, etc., which is formed in a concave shape along the hinge part 52. Accordingly, a predetermined space is formed between the hinge part 52 and the surface of the attaching counterpart 200 arranged near the hinge part 52 and thus preventing the adhesive material provided between the vibration direction converter part 50 and the attaching counterpart 200 from affecting the hinge part 52. As shown in the drawings, the notch part 71 as the contact avoiding part 70 is formed at the connecting part 60, which is the attaching counterpart 200, such that the notch part 71 is located in proximity of the hinge part 52 (52A), while the concave portion 72 as the contact avoiding part 70 is formed at the diaphragm 10, such that the concave portion 72 is located in proximity of the hinge part 52 (52B). As such, when the connecting part 53 of the vibration direction converter part 50 and the connecting part 60 or the end face of the diaphragm 10 are applied with the joining member such as adhesive, double-faced tape, etc., the adhesive and the end of the double-faced tape running off toward the hinge part 52 enter into the notch part 71 or the concave portion 72, and thus preventing them from contacting and adhering to the hinge part 52.

In the above-mentioned speaker unit 1U, when an audio signal SS as an electric signal is inputted to the voice coil 30 of the driving part 14 as shown in FIG. 2 (a), the voice coil 30 or the voice coil support part 40 vibrates along the magnetic gap 20G of the magnetic circuit 20, for example, in X-axis direction of the drawings as shown in FIG. 2 (b). Accordingly, the direction of the vibration is converted by the vibration direction converter part 50 and the vibration is transmitted to the diaphragm 10 such that the diaphragm 10 is vibrated, for example, in Z-axis direction of the drawings, thereby a sound in response to the audio signal is emitted in the sound emission direction SD.

In the speaker unit 1U as described above, since the direction of the vibration produced by the voice coil 30 and the vibration direction of the diaphragm 10 are different from each other by using the vibration direction converter part 50, the thickness of the speaker unit 1U on the rear side of the diaphragm 10 may be made smaller than the thickness of the speaker, of which the voice coil 30 is vibrated in the vibration direction of the diaphragm 10. As such, a thin speaker device, which may reproduce a low frequency range with a high sound pressure, may be realized.

Further, since the direction of the vibration produced by the voice coil 30 is converted by the vibration converter part 50 and the vibration is transmitted to the diaphragm 10, the thickness in sound emission direction of the speaker unit 1U (total height of the speaker unit) is not increased even if the amplitude of vibration of the diaphragm 10 is increased by increasing the amplitude of vibration of the voice coil 30. As such, a thin speaker device, which may emit a loud reproduced sound, may be realized.

Further, when the connecting part 53 of the direction converter part 50 and the attaching counterpart 200 are connected to each other by using the adhesive as an joining member, if the adhesive spreads out and runs off toward the hinge part 52 due to the join, and adheres to the hinge part 52, the hinge part 52 may be hardened and lose mobility. Also, when the double-faced tape is used as the joining member, if the end of the double-faced tape runs off toward the hinge part 52 and the double-faced tape adheres to the hinge part 52, the hinge part 52 may be hardened and lose mobility. In addition, the hinge part 52, which is adhered to and hardened by the adhesive, the end of the double-faced tape, etc. adhered thereto, may be subject to fracture by the repetition of bending, folding or rotational motion. If the hinge part 52 fractures as described above, the part to which the adhesive or the end of the double-faced tape adheres may repeatedly contact with and separate from the diaphragm 10, the voice coil 30 or the attaching counterpart 200 as other members, etc., and thus an abnormal noise (contact sound) may be generated each time. On the other hand, if the applied volume of the adhesive or the joining area by the double-faced tape is limited such that the adhesive or the double-faced tape does not run off and adhere to the hinge part 52, the coupling force between the vibration direction converter part 50 and the attaching counterpart 200 may be reduced, then detachment, etc. may occur at the end face, causing abnormal noise, or if a total detachment occurs, the speaker may eventually be fractured. Furthermore, since the hinge part 52 is arranged near the attaching counterpart 200, the hinge part 52 may contact the attaching counterpart 200. Therefore, the hinge part 52 damages, or there is a case that the vibration direction converter part 50 cannot bend, fold or rotate with respect to the attaching counterpart 200. However, in this speaker unit 1U, since the contact avoiding part 70 is formed on the surface side of the attaching counterpart 200 in proximity of the hinge part 52, it is possible to prevent the attaching counterpart 200 from contacting the hinge part 52 and restrain the generation of abnormal noise, etc. due to the contact. Further, even if the joining member such as the adhesive, double-faced tape, etc., which is used for coupling the connecting part 53 of the vibration direction converter part 50 and the attaching counterpart 200, runs off, the joining member enters into the contact avoiding part 70 that also functions as a joining member restraining part, and thus it is possible to restrain adherence of the joining member to the hinge part 52 causing hindrance to mobility thereof. As such, the function of the hinge part 52 may be maintained while the coupling force between the vibration direction converter part 50 and the attaching counterpart 200 is maintained large. Since the vibration direction converter part 50 securely bends, folds or rotates with respect to the attaching counterpart 200, contact of the hinge part 52 to the attaching counterpart 200, generation of the abnormal noise, etc. due to fracture may be restrained.

### (Vibration Direction Converter Part)

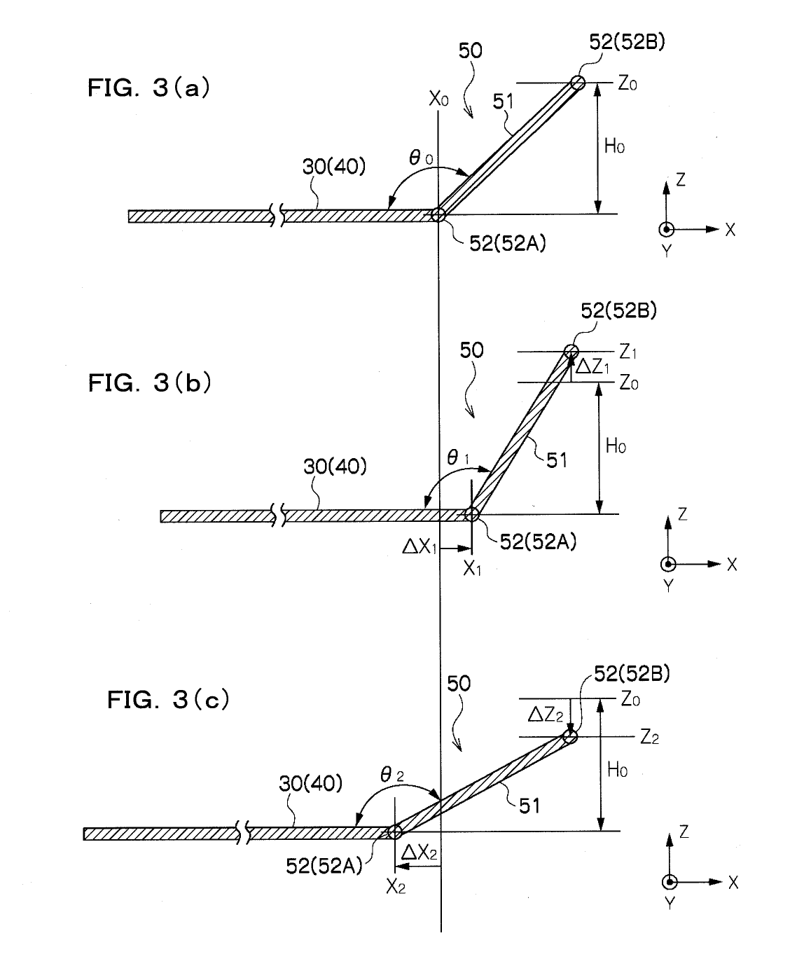

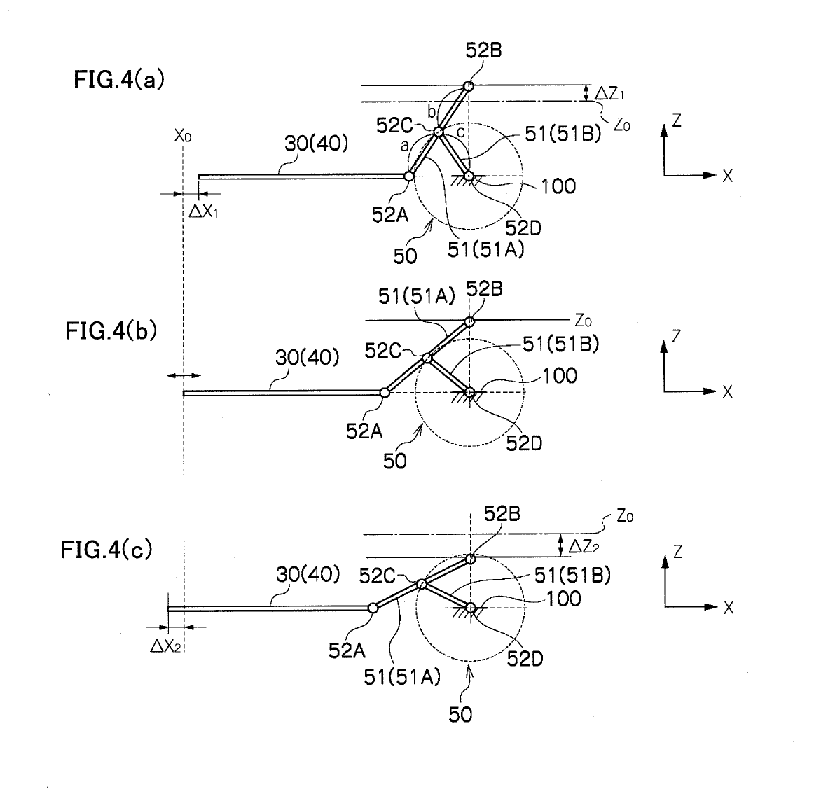

FIGS. 3 and 4 are views illustrating a configuration example and an operation of the vibration direction converter part 50. The rigid vibration direction converter part 50, direct-converting the vibration of the voice coil 30 and transmitting it to the diaphragm 10, has hinges 52 formed on the sides of the diaphragm 10 and the voice coil 30 respectively, and has the link part 51 obliquely disposed with respect to the vibration direction of the voice coil 30. The hinge part 52 is a part that rotatably joins two rigid members or a part that bends or bendably joins integrated two rigid parts, while the link part 51 is a rigid part having the hinge parts 52 formed at the ends. The rigidity means that the members and the parts are not so deformable that the vibration of the voice coil 30 can be transmitted to the diaphragm 10. It does not mean that they are totally undeformable. The link part 51 can be formed in a plate shape or in a rod shape.

In the embodiment shown in FIG. 3, one link part 51 has the hinge parts 52 (52A, 52B) formed at both ends such that the one hinge part 52A is formed at the end of the voice coil 30 or the voice coil support part 40, while another hinge part 52B is formed on the side of the diaphragm 10. Another hinge part 52B may be connected to the diaphragm 10 or connected to the diaphragm 10 via other member. A conventional member may be used as other member. For example, a metal material, etc. improving join strength between the hinge part 52 and the diaphragm 10, may be selected (diaphragm 10 is not shown in FIG. 3).

FIG. 3(a) shows that the link part 51 is in the middle position of the vibration. The link part 51 is obliquely disposed between the voice coil 30 (or voice coil support part 40) and the diaphragm 10 at an angle θ₀. Meanwhile, the hinge part 52B on the side of the diaphragm 10 is arranged at the position Z₀ apart from the voice coil 30 by distance H₀ in the vibration direction of the diaphragm 10. The vibration direction of the voice coil 30 (or voice coil support part 40) is restricted such that it may vibrate in one axis direction (for example, X-axis direction), while the vibration direction of the diaphragm 10 is restricted such that it may vibrate in a direction (for example, Z-axis direction) different from the vibration direction of the voice coil 30.

As shown in FIG. 3(b), when the hinge part 52A formed at the end of the voice coil 30 moves from position X₀ to position X₁ by ΔX₁, in the vibration direction (X-axis direction), the inclination angle of the link part 51 is converted to be θ₁ (θ₀>θ₁) and the position of the hinge part 52B on the side of the diaphragm 10 moves to position Z₁ by ΔZ₁ in the vibration direction of the diaphragm 10 (Z-axis direction). More specifically, the diaphragm 10 is pushed up by ΔZ₁ in the vibration direction.

As shown in FIG. 3(c), when the hinge part 52A formed at the end of the voice coil 30 moves from the original position X₀ to the position X₂ by ΔX₂ in the vibration direction (−X-axis direction), the inclination angle of the link part 51 is converted to be θ₂ (θ₀<θ₂) and the position of the hinge part 52B on the side of diaphragm 10 moves to position Z₂ by ΔZ₂ in the vibration direction of the diaphragm 10 (−Z-axis direction). More specifically, the diaphragm 10 is pushed down by ΔZ₂ in the vibration direction.

As such, the vibration direction converter part 50, including the link part 51 and the hinge part 52 (52A, 52B), converts vibration of the voice coil 30 to the change in the angle of the link part 51 obliquely disposed and transmits it to the diaphragm 10, and thus vibrating the diaphragm 10 in a direction different from the vibration direction of the voice coil 30.

FIG. 4 is a view illustrating another configuration example and the operation of the vibration direction converter part 50. Specifically, FIG. 4(b) shows a state of the vibration direction converter part 50 when the diaphragm 10 is positioned in a reference position, FIG. 4(a) shows a state of the vibration direction converter part 50 when the diaphragm 10 is displaced to the sound emission side from the reference position and FIG. 4(c) shows a state of the vibration direction converter part 50 when the diaphragm 10 is displaced in the direction opposite to the sound emission side from the reference position (diaphragm 10 is not shown).

The vibration direction converter part 50 has a function that the link part 51 can angle-convert by receiving reaction force from a static part 100 such as the frame 12 positioned on the opposite side of the diaphragm. Specifically, the vibration direction converter part 50 includes a first link part 51A having one end on the side of the voice coil 30 as a hinge part 52A while another end on the side of the diaphragm 10 as a hinge part 52B and a second link part 51B having one end as a hinge part 52C to the middle part of the first link part 51A while another end as a hinge part 52D to the static part 100, and the first link part 51A and the second link part 51B are obliquely disposed in different directions with respect to the vibration direction of the voice coil 30. More specifically, the vibration direction converter part 50 includes a first link part 51A having one end on the side of the voice coil 30 as a first hinge part 52A while another end on the side of the diaphragm 10 as a second hinge part 52B and a second link part 51B having one end as a third hinge part 52C to the middle part of the first link part 51A while another end as a fourth hinge part 52D to the static part 100, and the first hinge part 52A, the second hinge part 52B and the fourth hinge part 52D are located on the circumference of a circle with a diameter of substantially the same length as the first link part 51A, having the third hinge part 52C as the center.

In the vibration direction converter part 50, the hinge part 52D, supported by the static part 100 (or frame 12), is only the hinge part that does not change position, and thus providing reaction force from the static part 100 for the link part 51. Accordingly, when the voice coil 30 (or the voice coil support part 40) moves from the reference position X₀ by ΔX₁ in the X-axis direction, angles of the first link part 51A and the second link part 51B that are obliquely disposed in different directions are increased by substantially the same angle as shown in FIG. 4(a), and thus the hinge part 52B, receiving reaction force from the static part 100 at the hinge part 52D, securely pushes up the diaphragm 10 from the reference position Z₀ by ΔZ₁ in the Z-axis direction. Further, when the voice coil 30 moves from the reference position X₀ by ΔX₂ in the direction opposite to the X-axis direction, angles of the first link part 51A and the second link part 51B are decreased by substantially the same angle as shown in FIG. 4(c), and thus the hinge part 52B, receiving reaction force from the static part 100 at the hinge part 52D, securely pushes down the diaphragm 10 from the reference position Z₀ by ΔZ₂ in the direction opposite to the Z-axis direction.

A length a of a link part from the hinge part 52A to the hinge part 52C, a length b of a link part from the hinge part 52C to the hinge part 52B and a length c of a link part from the hinge part 52C to the hinge part 52D are configured to be substantially the same as each other, and thereby the hinge part 52A and the hinge part 52D are preferably arranged substantially in parallel with the moving direction of the voice coil 30. This link body is well known as a “Scott Russell linkage” where the hinge parts 52A, 52B and 52D are located on the circumference of a circle with the length of the first link part 51A (a+b=2a) as the diameter and the hinge part 52C as the center of the circle. In particular, the angle defined by the line passing through the hinge part 52A and the hinge part 52D and the line passing through the hinge part 52B and the hinge part 52D becomes a right angle. As such, when the voice coil 30 is moved in the X-axis direction, the hinge part 52B between the first link part 51A and the diaphragm 10 moves in the Z-axis direction that is perpendicular to the X-axis, and thus it is possible to convert the vibration direction of the voice coil 30 to its orthogonal direction and transmit the vibration to the diaphragm 10.

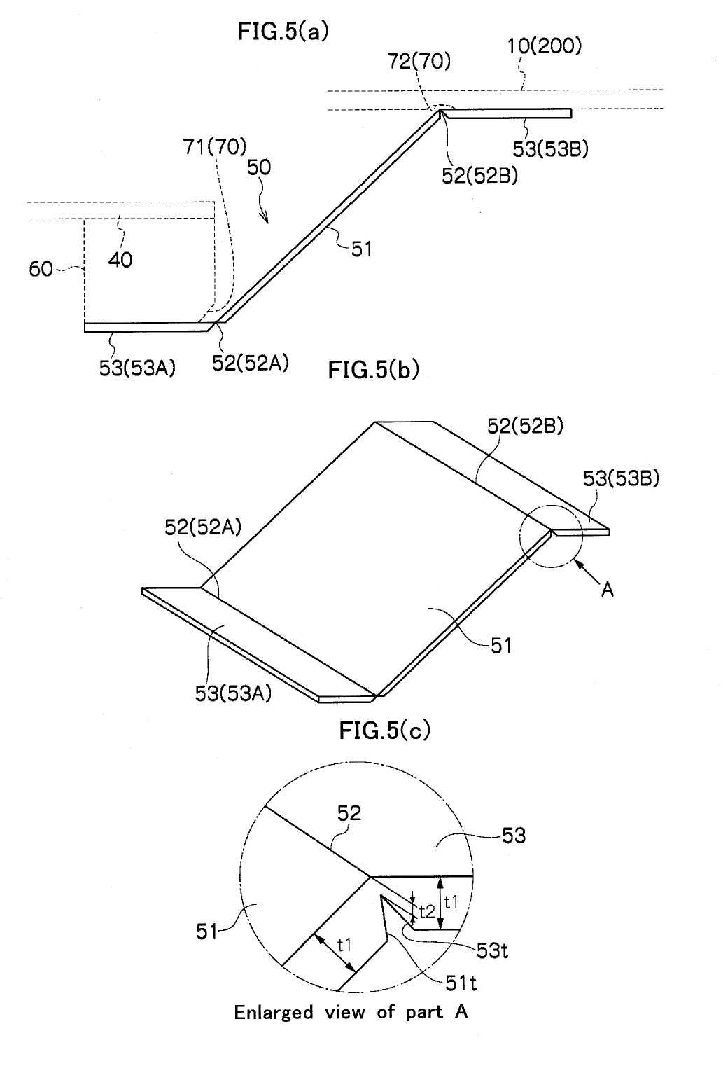

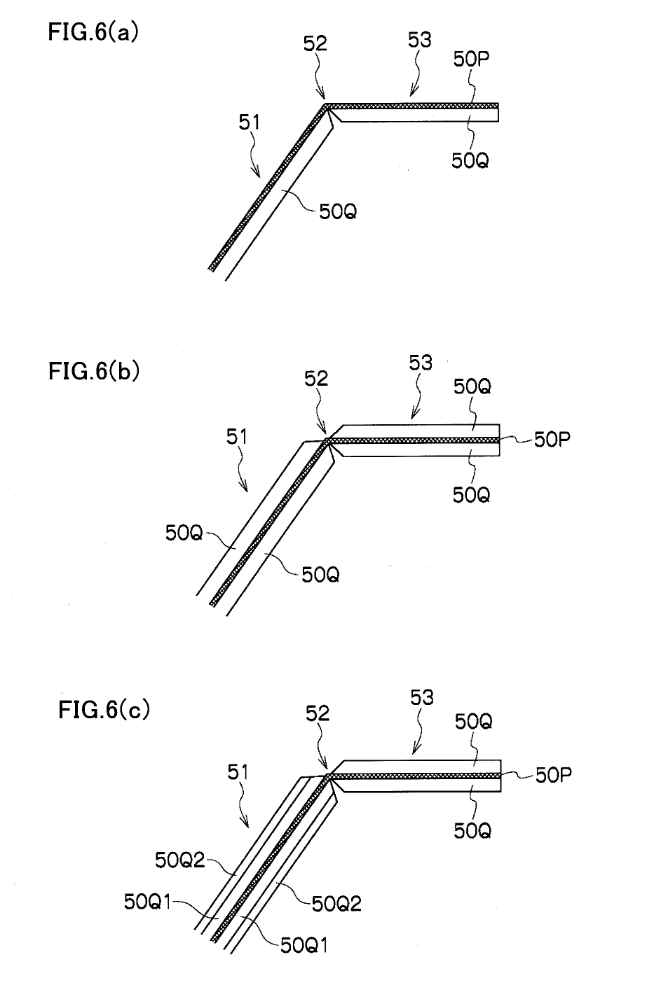

FIGS. 5 and 6 are views illustrating a formation example of the vibration direction converter part (FIG. 5(a) is a side view, FIG. 5(b) is a perspective view and FIG. 5(c) is an enlarged view of part A). The vibration direction converter part 50 includes the link part 51 and the hinge parts (52A, 52B) formed at both ends of the link part 51 as described above. As shown in the drawings, connecting parts 53 (first connecting part 53A and second connecting part 53B) are formed at both ends of the link part 51 via hinge parts 52. The first connecting part 53A, connected to the voice coil 30 or the voice coil support part 40 directly or via other member, integrally vibrates with the voice coil 30, while the second connecting part 53B, connected to the diaphragm 10 directly or via other member, integrally vibrates with the diaphragm 10.

In the vibration direction converter part 50, the link part 51, the hinge parts 52A and 52B, the first and second connecting parts 53A and 53B are integrally formed, and the hinge parts 52A and 52B are formed with a bendable continuous member continuing between the parts of both sides over the hinge parts 52A and 52B. This continuous member may be a member configuring the link part 51 and the first and the second connecting part 53A and 53B as a whole, or may be a member configuring the link part 51 and a part of the first and second connecting parts 53A and 53B. Provided with this second connecting part 53B, the link part 51 may support the diaphragm 10 over a wide range, and thereby it is possible to vibrate the diaphragm 10 in the same phase. The term “fold” includes “bend” in its conceptual scope.

If the vibration direction converter part 50 is formed with a plate shape member, the hinge part 52 is linearly formed extended in a width direction as shown in FIG. 5 (b). Further, the link part 51 is required to be rigid and not to be deformable. Since the hinge part 52 is required to be bendable, the integral member is configured to have a different property by forming the thickness t2 of the hinge part 52 smaller than the thickness t1 of the link part 51 or the connecting part 53.

Further, the change in thickness of the hinge part 52 and the link part 51 is formed on a slant face, and the slant faces 51t and 53t, facing the ends of the parts of both sides over the hinge part 52, are formed. As such, when the link part 51 is angle-varied, interference to the angle variation by thickness of the link part 51 may be restrained.

Further, a concave portion or notch part 71, which acts as a contact avoiding part 70, is formed at the end of the connecting part 60 that is an attaching counterpart 200 arranged near the hinge part 52A, such that a space is formed between the hinge part 52A and the connecting part 60 as shown in FIG. 5(a). In an example shown in FIG. 5(a), the notch part is formed in a slantwise cross-sectional shape. Furthermore, a concave portion or notch part 72, which acts as a contact avoiding part 70, is formed at the diaphragm 10 that is an attaching counterpart 200 arranged near the hinge part 52B, such that a space is formed between the hinge part 52B and the diaphragm 10. In an example shown in FIG. 5(a), the concave portion is formed in a curved cross-sectional shape. As such, contact between the hinge parts 52A, 52B and the attaching counterpart 200 may be restrained. Further, when joining the first connecting part 53A of the link part 51 with the end face of the connecting part 60, and joining the second connecting part 53B with the diaphragm 10 respectively with adhesive as a joining member, even if the adhesive runs off toward the hinge parts 52A, 52B, it will run into the concave portion or the notch part 71, 72, and therefore it will not adhere to the hinge parts 52A, 52B. Since the adhesive only adheres to a non-hinge part (unbendable or unfoldable rigid part) even if the adhesive adheres, interference to bending or folding of the hinge parts 52A, 52B may be restrained.

In an example shown in FIG. 6, a link part or a connecting part is configured by integrating a bendable continuous member and a rigid member, and a hinge part is a part that is configured by the continuous member. In the example shown in FIG. 6(a), the link part 51 or the connecting part 53 is configured by joining a rigid member 50Q to the surface of a continuous member 50P that is a bendable sheet-shaped member. According to this configuration, the continuous member 50P continuously extends between the parts of both sides over the hinge part 52, and the hinge part 52 is bendably formed substantially only by the continuous member 50P. Meanwhile, the link part 51 or the connecting part 53, which is formed by joining the rigid member 50Q to the continuous member 50P, may be formed as a rigid part.

In an example shown in FIG. 6(b), the rigid members 50Q are applied to sandwich the continuous member 50P to form the link part 51 or the connecting part 53. Also, the part, not applied with the rigid member 50Q, becomes the hinge part 52. In an example shown in FIG. 6(c), the rigid member forming the link part 51 is formed in multiple layers laminated by the rigid members 50Q1 and 50Q2. Further, in FIG. 6(c), the rigid member 50Q1 and the rigid member 50Q2 may be formed in a multiple-layer structure. As such, the bendable hinge part 52 and the rigid link part 51 and connecting part 53 may be integrally formed by partially joining the rigid member 50Q to the bendable continuous member 50P.

The continuous member 50P is preferably configured to have strength and durability durable against repeated bending of the hinge part 52 when the speaker unit is driven, and have flexibility making little noise when bending is repeated. According to one embodiment, the continuous member 50P may be formed with a woven or an unwoven material made of high-strength fiber. As an example of the woven material, plain weave with uniform material, plain weave having different warp and weft material threads, plain weave with alternately changed thread material, plain weave with twisted union yarn and plain weave with paralleled yarn. Other than plain weaves, there may be applied triaxial and quadraxial woven fabrics, triaxial and quadraxial continuous non-woven fabric of glued layer, knitting, fabric with paralleled yarn in one direction, etc.

When the high-strength fiber is applied partially or as a whole, sufficient strength against vibration of the voice coil 30 or the voice coil support part 40 may be achieved by arranging the high-strength fiber in the vibration direction of the voice coil support part 40. When applying both the warp and the weft thread as the high-strength fiber, durability may be improved with a uniform tensile force given to the warp and the weft thread by inclining both fiber directions by 45° with respect to the vibration direction of the voice coil support part 40. As the high-strength fiber, aramid fiber, carbon fiber, glass fiber, etc. may be used. Further, a damping material may be applied to adjust characteristic such as bending stress and rigidity of the continuous member.

As the rigid member 50Q, thermoplastic resin, thermosetting resin, metal, paper, etc., which are light weight, easy to mold and having rigidity after hardening, may preferably be used. The vibration direction converter part 50 may be configured by joining the rigid member 50Q, which is molded in a plate shape, to the surface of the continuous member 50P other than the part of the hinge part 52 by using adhesive as a joining material. Further, if thermosetting resin is used as the rigid member 50Q, the vibration direction converter part 50 may be configured by impregnating partially the link part 51 or the connecting part 53 of the fibrous continuous member 50P with resin and then hardening it. Further, if resin or metal is used as the rigid member 50Q, the continuous member 50P and the rigid member 50Q may be integrated at the link part 51 and the connecting part 53 by using insert molding. The above-mentioned technology concerning the integral forming is described in US20050127233 (Publication No. US2005/253298) filed in the US on May 12, 2005 and US20050128232 (Publication No. US2005/253299) filed in the US on May 13, 2005, which is incorporated here in the present application.

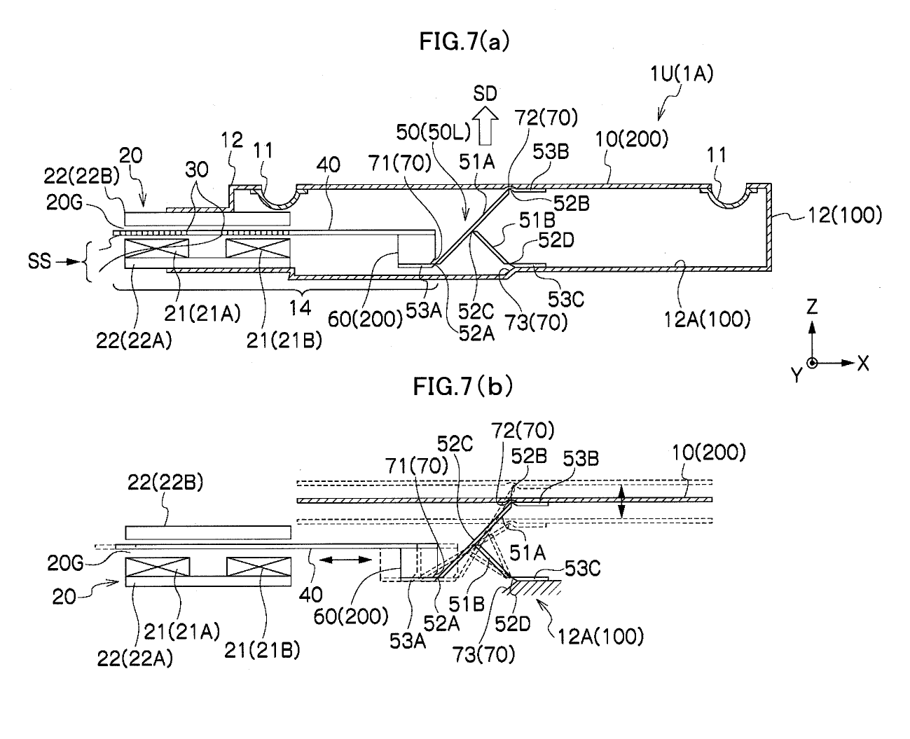

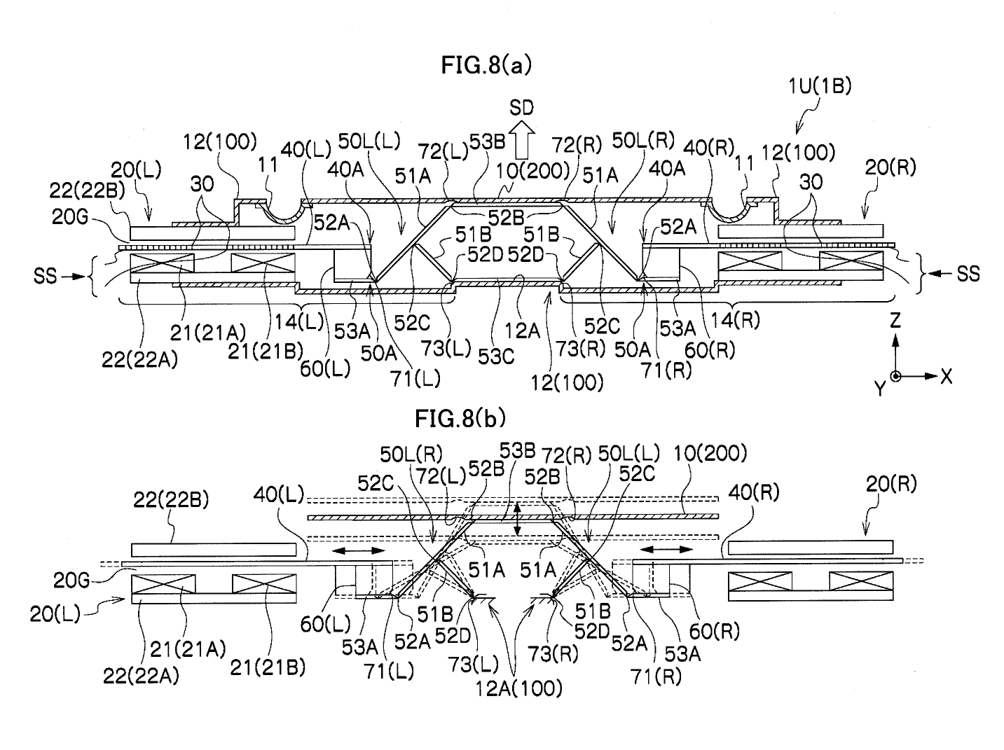

FIGS. 7 and 8 are views illustrating a speaker device adopting the above-mentioned vibration direction converter part (FIGS. 7(a) and 8(a) are cross-sectional views taken in X-axis direction and FIGS. 7(b) and 8(b) are views illustrating an operation of the driving part). The same symbols are applied to the same parts and a part of duplicate descriptions is eliminated. In a speaker unit 1 U (1A, 1B) shown in FIGS. 7 and 8, a link body 50L is configured to include the first connecting part 53A that is connected to the voice coil support part 40 and vibrates integrally with the voice coil support part 40 and the second connecting part 53B that is connected to the diaphragm 10 and vibrates integrally with the diaphragm 10 as well as a plurality of link parts.

In the speaker unit 1 U (1A) shown in FIG. 7, the vibration direction converter part 50 is formed with the link body 50L including the rigid first link part 51A and second link part 51B. The first connecting part 53A is located at one end of the first link part 51A via the hinge part 52A while the second connecting part 53B is located at another end of the first link part 51A via the hinge part 52B. The middle part of the first link part 51A is located at one end of the second link part 51B via the hinge part 52C while the connecting part 53C, which is static with respect to vibration of the voice coil support part 40, is located at another end of the second link part 51B via the hinge part 52D.

According to the drawings, the first connecting part 53A is connected to the end of the voice coil support part 40 directly or via the connecting part 60, the second coupling part 53B is directly connected to the diaphragm 10 and the static connecting part 3C is coupled to the bottom portion 12A of the frame 12 that is the static part 100. A concave portion or a notch part 73, which acts as a contact avoiding part 70, is formed at the bottom portion 12A of the frame 12 that is an attaching counterpart 200 arranged near the hinge part 52D, such that a space is formed between the hinge part 52D and the bottom portion 12A of the frame 12. In an example shown in the drawings, the notch part is formed. The first link part 51A and the second link part 51B are obliquely disposed in different directions with respect to the vibration direction (X-axis direction) of the voice coil support part 40 and the static part 100 is provided on the opposite side of the diaphragm 10 with respect to the vibration direction converter part 50. In the example shown in the drawings, although the static part 100 is formed with the bottom portion 12A of the frame 12, a yoke 22A of a magnetic circuit 20 may be the static part 100 instead of the bottom portion 12A of the frame 12 by extending the yoke 22A of the magnetic circuit 20 to the position under the vibration direction converter part 50.

As shown in FIG. 7(b), the hinge part 52A on the side of the voice coil support part 40 moves in the X-axis direction in accordance with the movement of the voice coil support part 40 while the hinge part 52D connected to the static part 100 is fixed. The movement of the hinge part 52A is converted to changing angles of the first link part 51A and the second link part 51B, and thus the hinge part 52B on the side of the diaphragm 10 is moved in the vibration direction of the diaphragm 10 (for example, Z-axis direction).

The speaker unit 1 U (1B) shown in FIG. 8 is configured with the driving parts 14 shown in FIG. 7 symmetrically disposed opposite to each other, which includes the driving parts 14(R) and 14(L), respectively. Each of the driving parts 14(R) and 14(L) includes a link body 50L(R) or 50L(L), a voice coil support part 40(R) or 40(L), a magnetic circuit 20(R) or 20(L) and a connecting part 60(R) or 60(L).

The link bodies 50L(R) and 50L(L) configure the vibration direction converter part 50 such that a pair of the first link parts 51A, a pair of the second link parts 51B, a pair of the first connecting parts 53A, the second connecting part 53B and the static connecting part 53C, which are disposed opposite to each other, are integrally formed. A pair of the first connecting parts 53A are connected to the voice coil support part 40 respectively, the second connecting part 53B is connected to the diaphragm 10, and the static connecting part 53C is connected to the bottom portion 12A of the frame 12.

As shown in FIG. 8(b), the diaphragm 10 may be driven by two combined driving forces of the driving parts 14(R) and 14(L) by setting the vibration directions of the voice coil support part 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

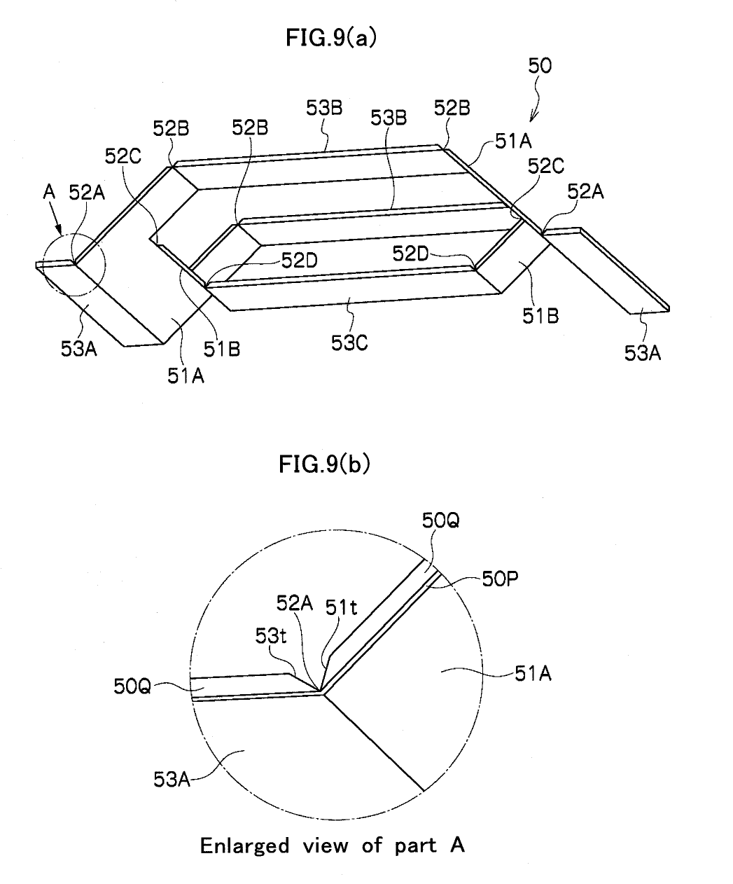

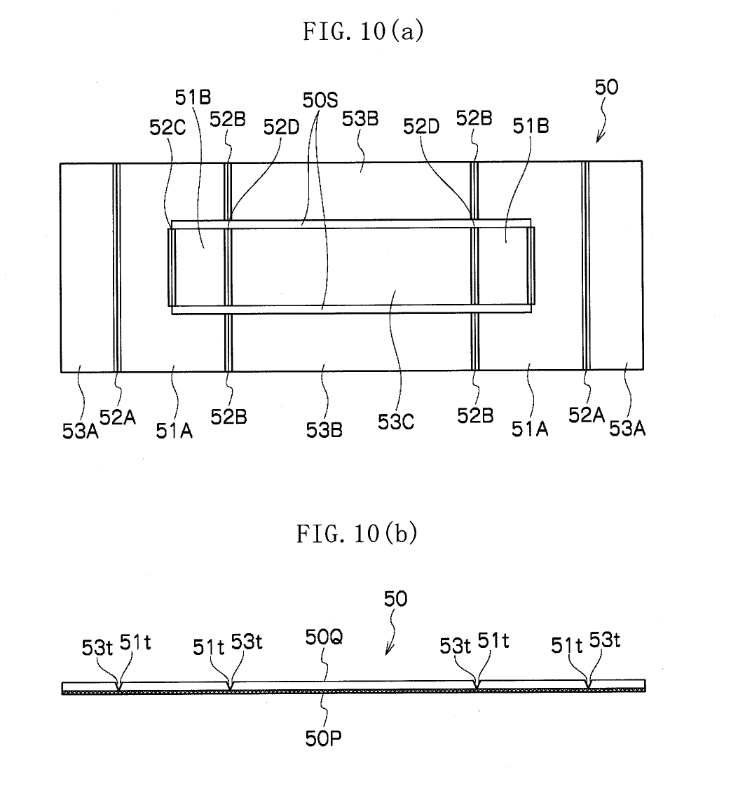

FIGS. 9 and 10 are views illustrating more specific vibration direction converter part (FIG. 9(a) is a perspective view, FIG. 9(b) is an enlarged view of part A in FIG. 9(a), FIG. 10(a) is a plan view illustrating a flattened whole part by unfolding the vibration direction converter part and FIG. 10(b) is a side view illustrating a flattened whole part by unfolding the vibration direction converter part. In this example, the vibration direction converter part 50 is formed with a single integrated component. As described above, the vibration direction converter part 50 is formed with a pair of the first link parts 51A, hinge parts 52A and 52B formed at both ends of the first link parts 51A, a pair of the second link parts 51B and hinge parts 52C and 52D formed at both ends of the second link parts 51B. Further, the first connecting parts 53A are formed at one ends of a pair of the first link parts 51A via the hinge parts 52A, the second connecting part 53B is formed between hinge parts 52B formed at other ends of a pair of the first link parts 51A and the static connecting part 53C is formed between the hinge parts 52D formed at other ends of the second link parts 51B. The first link parts 51A, 51A and the second connecting part 53B are bent in a convex shape and the second link parts 51B, 51B and the static connecting part 53C are bent in a concave shape.

As shown in FIG. 9(b), the hinge part 52A is bendably formed with the above continuous member 50P. The above rigid member 50Q is attached to the first link part 51A and also to the first connecting part 53A. Also, the first connecting part 53A is joined by the above rigid member 50Q. As such, all of the above-mentioned hinge parts are formed in the similar configuration. Further, slant faces 51t and 53t are formed opposite to each other in each hinge part.

As shown in FIG. 10(a), the vibration direction converter part 50, including the link parts 51A, 51B, each hinge part and the connecting part 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are formed in a longitudinal direction of the integral sheet-shaped member such that the second link parts 51B, 51B and the static coupling part 53C are cut out and formed.

As shown in FIG. 10(b), the vibration direction converter part 50 is formed, for example, by applying resin material forming the rigid member 50Q to the whole surface of the continuous member 50P that is a sheet-shaped member, such that the resin material is laminated on the continuous member 50P, and cutting in a V-shape to form each hinge part and the slant faces 51t and 53t at both sides thereof. After that, the above-mentioned notch part 50S is formed and the resin material is hardened. A liquid unhardened resin material or resin film may be used as the resin material used in this embodiment.

Further, each hinge part and the slant faces 51t and 53t at both sides thereof may be formed at the same time as forming the rigid member 50Q with the resin material. It is preferable that a cross-sectional V-shape groove or a concave portion is formed preliminarily in a die, which is used to mold the rigid member 50Q.

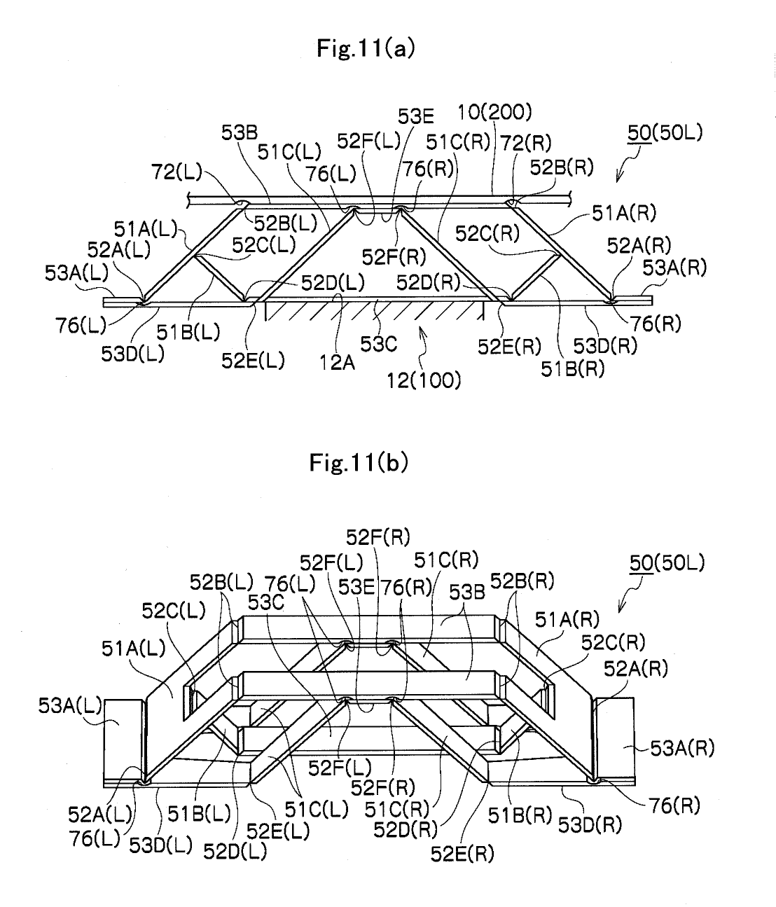

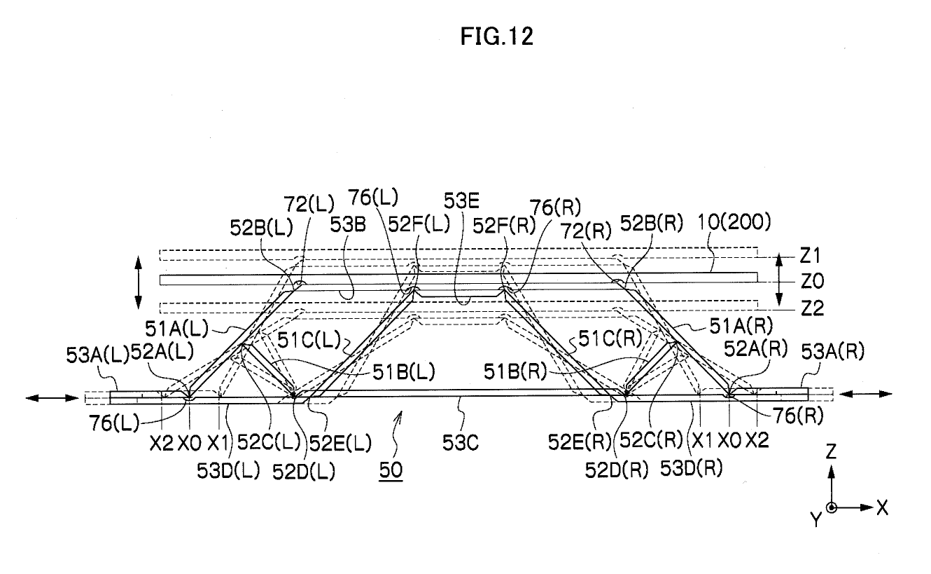

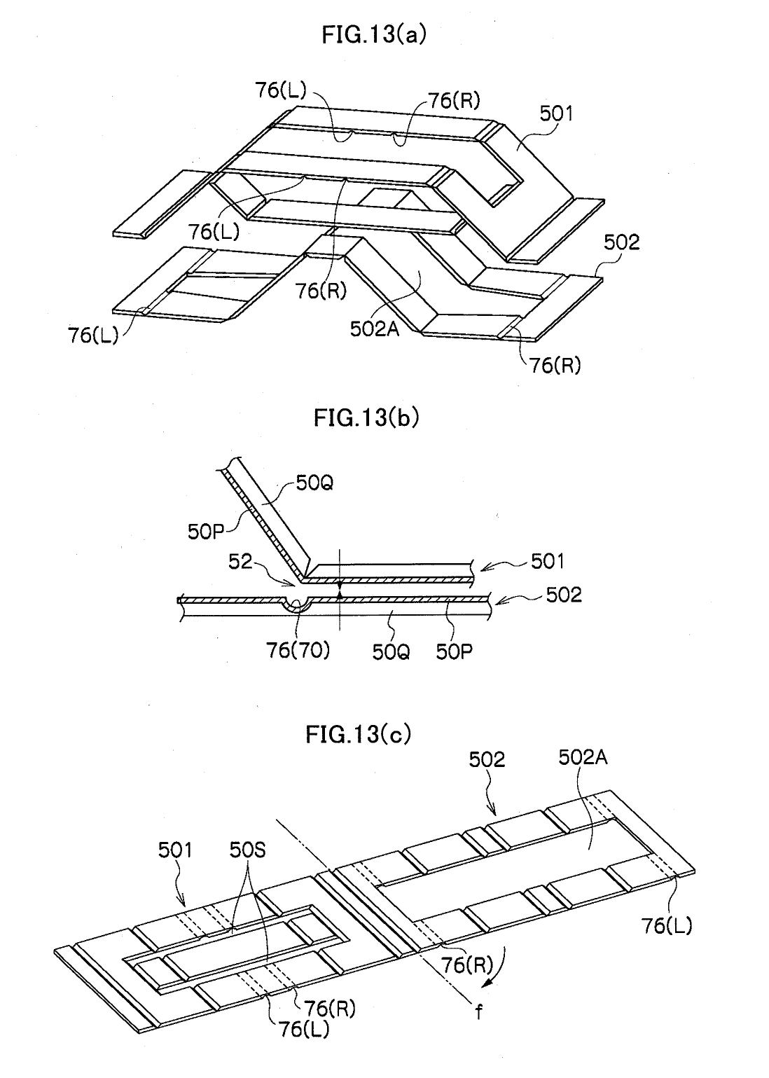

FIGS. 11, 12 and 13 are views illustrating other examples of the vibration direction converter part 50 (FIG. 11(a) is a side view, FIG. 11(b) is a perspective view, FIG. 12 is a view illustrating an operation and FIGS. 13(a) and 13(b) are views illustrating formation examples). The vibration direction converter part 50 (link body 50L) includes a pair of driving parts. In this embodiment, the vibration direction converter parts 50 are substantially symmetrically disposed opposite to each other and a parallel link is formed with a plurality of link parts.

The vibration direction converter part 50 includes a pair of first link parts 51A(R) and 51A(L) having a hinge part 52A(R) and 52A(L) to a first connecting part 53A (R) and 53A (L) at one end, and having a hinge part 52B(R) and 52B(L) to a second connecting part 53B at another end. Also, the vibration direction converter part 50 includes a pair of second link parts 51B(R) and 51B(L) having hinge parts 52C(R) and 52C(L) to the middle parts of the first link parts 51A(R) and 51A(L) at one end, and having hinge parts 52D(R) and 52D(L) to the static connecting part 53C at another end. As described above, the first connecting part 53A is connected to the voice coil 30 or the voice coil support part 40 directly or via the connecting part 60 as other member, while the second connecting part 53B is connected to the diaphragm 10 and the static connecting part 53C is connected to the bottom portion 12A of the frame 12 that is the static part 100, the yoke 22, etc. forming the magnetic circuit 20.

Further the vibration direction converter part 50 includes a pair of third link parts 51C(R) and 51C(L) having hinge parts 52E(R) and 52E(L) at one end to a pair of the connecting parts 53D(R) and 53D(L) integrally extending from the first connecting part 53A (R) and 53A (L), and having hinge parts 52F (R) and 52F (L) at another end to a connecting part 53E that is integral with the second connecting part 53B.

Further, the first link part 51A(R) and the third link part 51C(R), the first link part 51A(L) and the third link part 51C(L), the second link part 51B(R) and the third link part 51C(L), and the second link part 51B(L) and the third link part 51C(R) form parallel links respectively.

This link body 50L of the vibration direction convertor part 50 substantially includes a function combining the link body of the embodiment shown in FIG. 7 and the parallel link body. Each link part and connecting part are formed by integrating the continuous member 50P with the rigid member 50Q, while each hinge part between link parts is linearly formed with the bendable continuous member 50P, and thus link parts are mutually integrally formed via hinge parts.

As shown in the drawings, the second connecting part 53B arranged near the hinge parts 52F (R) and 52F (L) and a pair of the connecting part 53D(R) and 53D(L) arranged near the hinge parts 52A(R) and 52A(L) form concave portions 76 as the contact avoiding part 70, such that a space is formed between each hinge part and connecting part.

An operation of the vibration direction converter part 50 is described with reference to FIG. 12. In this embodiment, the static connecting part 53C functions as the static part 100. According to the vibration direction converter part 50, when the hinge parts 52A(R) and 52A(L) is moved from the reference position X0 to X1 in the X-axis direction in accordance with vibration of the voice coil support part 40, the second connecting part 53B and the connecting part 53E integrally with the second connecting part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D(R) and 52D(L) are supported at both ends of the static connecting part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X-axis direction, the second connecting part 53B and the connecting part 53E integrally with the second connecting part 53B are moved down keeping a parallel state by the parallel link body, while angles of the first link parts 51A(R) and 51A(L) and the third link parts 51C(R) and 51C(L), which configure a parallel link, are varied as they are laid. Since the hinge parts 52D(R) and 52D(L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this vibration direction converter part 50, the vibration in the X-axis direction of one voice coil support part 40 is converted to the vibrations in the Z-axis direction of the hinge parts 52B(R) and 52B(L), 52F (R) and 52F (L), and the second connecting part 53B, which vibrate substantially in the same phase and the same amplitude. As such, since the diaphragm 10 is supported over a large area and given the vibration that has substantially the same phase and the same amplitude, the vibration of the voice coil support part 40 may be transmitted substantially in the same phase to the planar diaphragm 10 with large area.

As shown in FIG. 11 (b), in the vibration direction converter part 50, a pair of the connecting parts 53B, 53D(R) and 53D(L) and the third link parts 51C(R) and 51C(L) are disposed in a width direction and parallel respectively. The first link parts 51A(R) and 51A(L) are formed in a biforked shape, and the hinge parts 52C(R) and 52C(L) to the second link parts 51B(R) and 51B(L) are formed at the middle parts of the first link parts 51A(R) and 51A(L). The second link parts 51B(R) and 51B(L) and the connecting part 53C are placed between a pair of the connecting parts 53B, 53D(R) and 53D(L) and the third link parts 51C(R) and 51C(L), which are disposed in a width direction and parallel.

With link parts configured with a single sheet-shape component as described above, the diaphragm 10 can be vibrated and supported by aface, and thereby the whole diaphragm 10 can be vibrated substantially in the same phase and divided vibration may be restrained.

Further, as shown in FIG. 11(b), in the vibration direction conversion part 50 of this embodiment, the first link parts 51A(R) and 51A(L), and the second connecting parts 53B are configured by folding the whole single sheet-shape component forming the link parts in a convex-trapezoid shape, while the second link parts 51B(R) and 51B(L), and the static connecting part 53C are configured by folding a partially taken-out portion of this plate component.

A method of configuring this vibration direction converter part 50 is described with reference to FIG. 13. According to one configuration method, this vibration direction convertor part 50 is formed by joining a plurality of sheet-shape components 501, 502 (for example, two components) as shown in FIG. 13(a). The first connecting parts 53A(R) and 53A(L), the first link parts 51A(R) and 51A(L), the second link parts 51B(R) and 51B(L), the second connecting parts 53B and the static connecting part 53C are formed in one sheet-shape component 501, while the connecting parts 53D, the third link parts 51C(R) and 51C(L) and the connecting parts 53E are formed in another sheet-shape component 502. And, the third link parts 51C(R) and 51C(L) and the connecting parts 53D(R) and 53D(L) are formed along the first link parts 51A(R) and 51A(L) and the second connecting parts 53B, and an opening 502A is formed in the sheet-shape component 502 corresponding to the second link parts 51B(R) and 51B(L) and the static connecting part 53C.

In this embodiment, the opening 502A, formed in another sheet-shape component 502 corresponding to the second link parts 51B(R) and 51B(L) and the static connecting part 53C of one sheet-shape component 501, is formed so as to expand inward from ends of another sheet-shape component 502. This configuration may prevent the second link parts 51B(R) and 51B(L), and the static connecting part 53C from contacting another sheet-shape component 502, and thus a smooth movement of the link body may be performed.

The two sheet-shape components 501 and 502, which are formed with the continuous member 50P and the rigid member 50Q, are applied with their continuous members 50P, 50P face-to-face as shown in FIG. 13(b). According to this arrangement, the continuous members 50P, 50P are integrated, and thereby hinge parts 52 may smoothly bend. Also in this case, the concave portion or the notch part 76 is formed as the contact avoiding part 70 near the hinge part 52.

Further, the slant face as shown in FIG. 5(c) is formed at the end of each link part near each hinge part. The slant face is formed such that the link parts do not interfere with each other when they bend at the hinge parts. Thus the link parts can efficiently bend at the hinge parts.

In another configuration example, the above-mentioned sheet-shape component 501 and the sheet-shape component 502 are integrally formed with the sheet-shape component 502 connected to the end of the sheet-shape component 501 as shown in FIG. 13(c). The vibration direction converter parts 50 shown in FIGS. 11 and 12 may be obtained by folding the integrated components along a folding line f in the direction of an arrow. In this example, the vibration direction converter part 50 may be simply configured by applying resin material forming the rigid member 50Q to the whole surface of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 10.

Further, when forming each hinge part and the slant faces 51t and 53t at the both sides thereof, the rigid member 50Q may be formed with the resin material and molded at the same time. It is preferable that a cross-sectional V-shape groove or a concave portion is preliminarily formed in a die, which is used to mold the rigid member 50Q.

In the vibration direction converter part 50 shown in FIGS. 8 to 13, since the link body of the vibration direction converter part 50 may be configured with a single integral component with respect to two opposing voice coil support parts 40, the assembly operation may be simplified as well when configuring a speaker unit provided with a pair of driving parts. Further, provided with the static connecting part 53C, the hinge parts 52D(R) and 52D(L) may be held at fixed positions even if they are not particularly supported by the frame 12 corresponding to opposing vibrations of the voice coil support parts 40 (a plurality of the voice coil support parts 40 vibrate in directions opposite to each other), and thus the vibration direction converter part may be simply built into a speaker unit.

Further, in the vibration direction converter part 50, since the right side first link part 51A(R) and the third link parts 51C(R), and the left side first link part 51A(L) and the third link parts 51C(L) form parallel links as the link body, the second connecting parts 53B fixed to the diaphragm 10 may be stably moved in parallel in the Z-axis direction corresponding to the opposing vibrations of the voice coil supporting parts 40. Accordingly, it is possible to apply stable vibrations to the planar diaphragm 10.

According to this speaker unit 1U (1A, 1B), when an audio signal SS is inputted, the voice coil support part 40 vibrates along the magnetic gap 20G formed in a direction different from the vibration direction admissible for the diaphragm 10, and this vibration is direction-converted by the vibration direction converter part 50 and transmitted to the diaphragm 10, and thereby vibrating the diaphragm 10 to emit a sound in the sound emission direction SD corresponding to the audio signal SS.

Since the direction of the magnetic gap 20G is configured to cross the vibration direction of the diaphragm 10 and the thickness direction of the speaker unit 1U (1A, 1B), increasing the driving force of the magnetic circuit 20 or the vibration of the voice coil 30 does not directly affect the size of the speaker unit 1U (1A, 1B) in the thickness direction (Z-axis direction). Accordingly, it is possible to make the speaker unit 1U (1A, 1B) thin while pursuing making a louder sound.

Further, since the vibration direction converter part 50 converts the vibration direction of the voice coil support part 40 and transmits the vibration to the diaphragm 10 through the mechanical link body, transmission efficiency of vibration is high. In particular, in the speaker unit 1U (1A, 1B) shown in FIGS. 7 to 8, since angle variation of the first link parts 51A and the second link parts 51B is produced by the vibration of the voice coil support part 40 and reaction force of the static part 100, vibration of the voice coil support part 40 may be more securely transmitted to the diaphragm 100. Accordingly, the speaker unit 1U (1A, 1B) may produce preferable reproducing efficiency.

Further, in the speaker unit 1U (1A, 1B) shown in FIGS. 2, 7, and 8, provided with the connecting part 60, interval in the Z-axis direction may be provided between the position of the end 40A of the voice coil support part 40 and the position of the end 50A of the vibration direction converter part 50. As such, the length(height) in the Z-axis direction (thickness) of the magnetic circuit 20 can be included in the length in the Z-axis direction of the vibration direction converter part 50, and thus the speaker unit 1U (1A, 1B) may be made thin while securing a sufficient length in the Z-axis direction for the magnetic circuit 20, which is required to secure a driving force. Further, provided with the connecting part 60, a necessary length of the direction converter part 50 (length of link parts 51) may be sufficiently secured even if the speaker unit 1U (1A, 1B) is made thin, and thus the amplitude of vibration of the diaphragm 10 may be comparatively large.

More particularly, a bottom portion 61 of the connecting part 60 is configured to slide over the bottom portion 12A of the frame 12 or the static part 100 with a predetermined distance therefrom, and thereby vibration of the voice coil support part 40 may be stabilized. Further, the end of the vibration direction converter part 50 can be linearly moved, and thus the end of the vibration direction converter part 50 connected to the diaphragm 10 can be securely and stably moved.

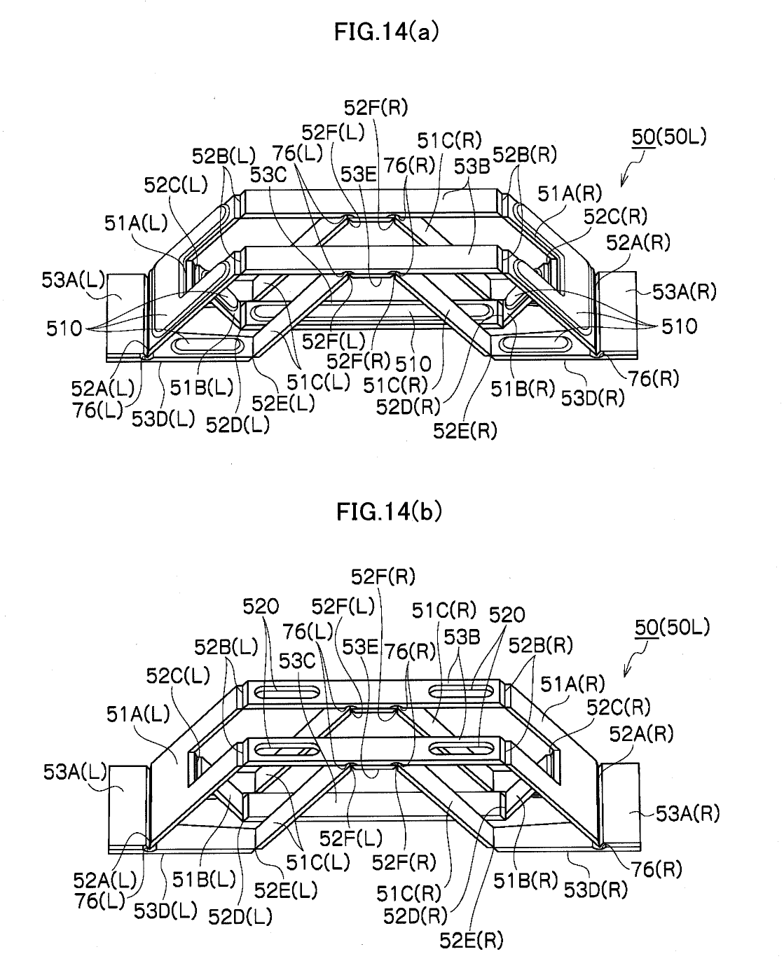

The vibration direction converter part 50 shown in FIG. 14 is a modified example of the embodiment shown in FIG. 11. In one example shown in FIG. 14(a), a convex portion 510 is provided on the link part that are subject to bend by opposing vibrations of the voice coil supporting parts 40, thereby rigidity of the link part can be increased. As shown in the drawing, the first link part 51A(R) and 51A(L), the second link parts 51B(R) and 51B(L), the connecting parts 53D(R) and 53D(L) and the connecting part 53C are provided with the convex portion 510 respectively. Further, in one example shown in FIG. 14(b), openings 520 are provided in the link part that need no particular strength, weight of the vibration direction converter part can be decreased. In the drawing, the connecting part 53B includes the openings 520. The weight reduction of the vibration direction converter part is effective to broaden a reproduction characteristic or increase amplitude and a sound pressure level of a sound wave corresponding to predetermined voice currents.

### (Power Feed Structure)

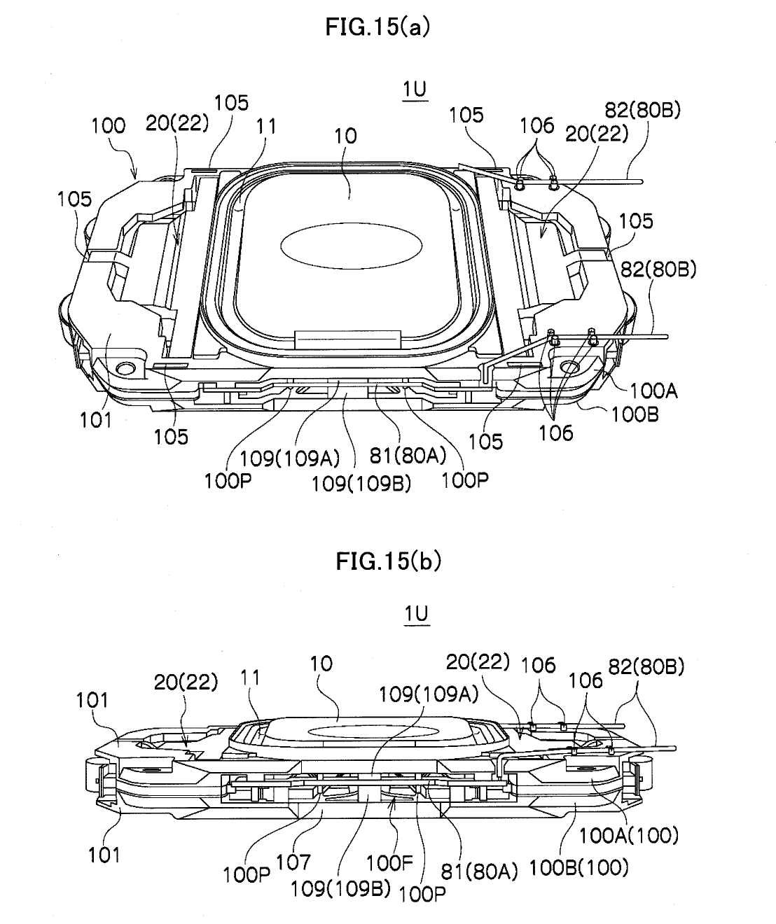

FIGS. 15 to 24 are views illustrating a power feed structure of the speaker unit according to one embodiment of the present invention. The speaker unit according to the embodiment of the present invention, with reference to the above-mentioned basic structure, includes the diaphragm 10, the static part 100 vibratably supporting the vibrating body 10 and the driving part 14, provided in proximity of the static part 100, vibrating the diaphragm 10 in response to an audio signal, while the driving part 14 includes a plurality of the voice coils 30, 30 vibrating in a direction different from the diaphragm 10 upon the inputted audio signal, a plurality of the magnetic circuits 20, 20 having the magnetic gaps 200, 200 in which the voice coils 30, 30 are arranged respectively and the rigid vibration direction converter part 50, which is obliquely disposed with respect to the vibration directions of the voice coils 30, 30 and the diaphragm 10, transmits the vibrations of the voice coils 30, 30 to the diaphragm 10.

Further, terminal parts 81, 81 common to a plurality of the voice coils 30, 30, which extend from one voice coil 30 to another voice coil 30 of the plurality of the voice coils 30, in order to input the audio signal to the plurality of the voice coils 30, 30, are provided on the static part 100. When a pair of the voice coils 30, 30 are provided, a pair of these terminal parts 81, 81 are provided and each one end of the pair of the voice coils 30, 30 is connected to one terminal part 81, while each another end of the pair of the voice coils 30, is connected to another terminal part 81. Provided with common terminal parts 81, 81 to a plurality of the voice coils 30, 30, a space for arranging the terminal parts may be reduced to be less than when the terminal parts are provided on one and another end of each voice coil 30. The space required for the terminal parts is reduced, and thereby a small sized or thin speaker unit may be produced.

Wirings (first wiring 80A) are formed at the terminal parts 81, 81 to electrically connect a plurality of the voice coils 30, 30. As such, the audio signal may be supplied to each of the plurality of the voice coils 30, 30 via the wirings when the audio signal is inputted to the terminal parts 81, 81.

FIGS. 15(a) and 15(b) are external perspective views of the speaker unit according to the embodiment of the present invention. The static part 100 of the speaker unit 1U is configured with a first configuring member 100A and a second configuring member 100B. The second configuring member 100B is a frame arranged on the side of the vibration direction converter part 50, and supports a part of the vibration direction converter part 50. The terminal parts 81, 81 are arranged between the first configuring member 10A and the second configuring member 100B. The first configuring member 100A is a frame arranged on the side of the diaphragm 10, and supports the diaphragm 10 via the edge 11. Further, the first configuring member 100A and the second configuring member 100B support the magnetic circuit 20. The first configuring member 100A supports one magnetic pole member (yoke 22) that is one side of the magnetic circuit 20. The second configuring member 100B supports another magnetic pole member (yoke 22) that is another side of the magnetic circuit 20. Thereby, a magnetic gap with a prescribed interval is formed between both magnetic pole members while the first configuring member 100A and the second configuring member 100B are coupled.

An opening 100F is configured with a concave portion formed between the opposing faces of the first configuring member 100A and the second configuring member 100B. Projection parts 109 (109A, 109B), supporting the terminal parts 81, 81, are formed at the first configuring member 100A and the second configuring member 100B, and the terminal parts 81, 81 are sandwiched between the projection part 109A and the projection part 109. As such, when the first configuring member 100A and the second configuring member 100B are coupled, the terminal parts 81, 81 may be concurrently stably fixed.

Further, as shown in FIG. 15, the static part 100 includes an outer-periphery frame 101 surrounding the magnetic circuit 20 and a bottom face part 107, and the terminal parts 81, 81 are formed in a shape along the outer-periphery frame 101 and are mounted on the outer-periphery frame 101. As such the terminal parts 81, 81 are not projected out of the outer-periphery frame 101 of the static part 100, the device can be made compact. Further, with the terminal parts 81, 81 mounted on the outer-periphery frame 101, the terminal parts 81, 81 may be stably fixed, and thereby bad connection with the voice coils 30, 30 may be avoided.

The terminal parts 81, 81 are formed in a shape having a long axis extending along one voice coil 30 to another voice coil 30 and a short axis crossing the long axis. With this longitudinal shape, efficiency of installation space may be improved.

The terminal parts 81, 81 may be arranged inside the outer-periphery frame 101. Therefore the terminal parts 81, 81 may be arranged without affecting shape or size of the outer circumference of the speaker unit. Further, the terminal parts 81, 81 may be arranged inside the outer-periphery frame 101 by using a technique of insert molding as necessary.

The respective outer-periphery frames 101, 101 of the first configuring member 100A and the second configuring member 100B include the above-mentioned openings 100F between faces opposing the voice coil 30, and the terminal parts 81, 81 are arranged in the opening 100F. In this case, the terminal parts 81, 81 act as reinforcing parts reinforcing the opening 100F of the static part 100.

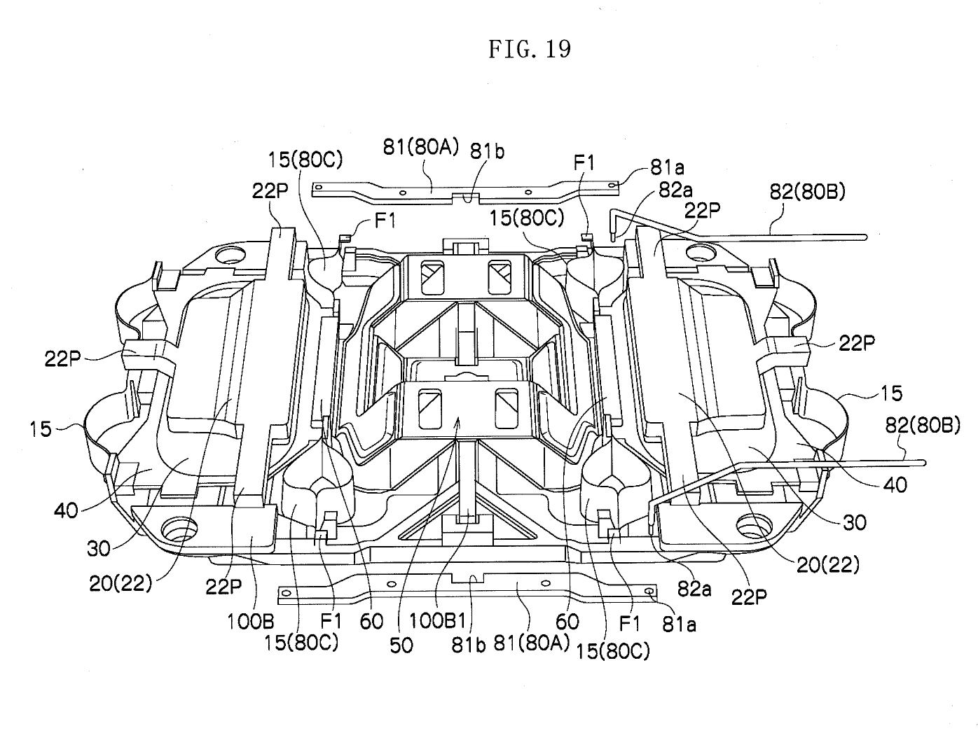

The terminal parts 81, 81 are provided with a connecting part 81a to wirings 82, 82 (second wiring 80A) that are electrically connected to outside (see FIG. 19), and a wiring (first wiring 80A) of the terminal parts 81, 81 and a wiring 82 (second wiring 80B) are electrically connected at the connecting part 81a. The wiring 82 (second wiring 80A) is fixed on the side face of the static part 100 and connected to the terminal parts 81, 81. The outer-periphery frame 101 of the static part 100 includes a side face on which the wiring 82 (second wiring 80B) is mounted, and guiding parts 106, 106 guiding the wirings 82, 82 are formed on the side face of the static part 100.

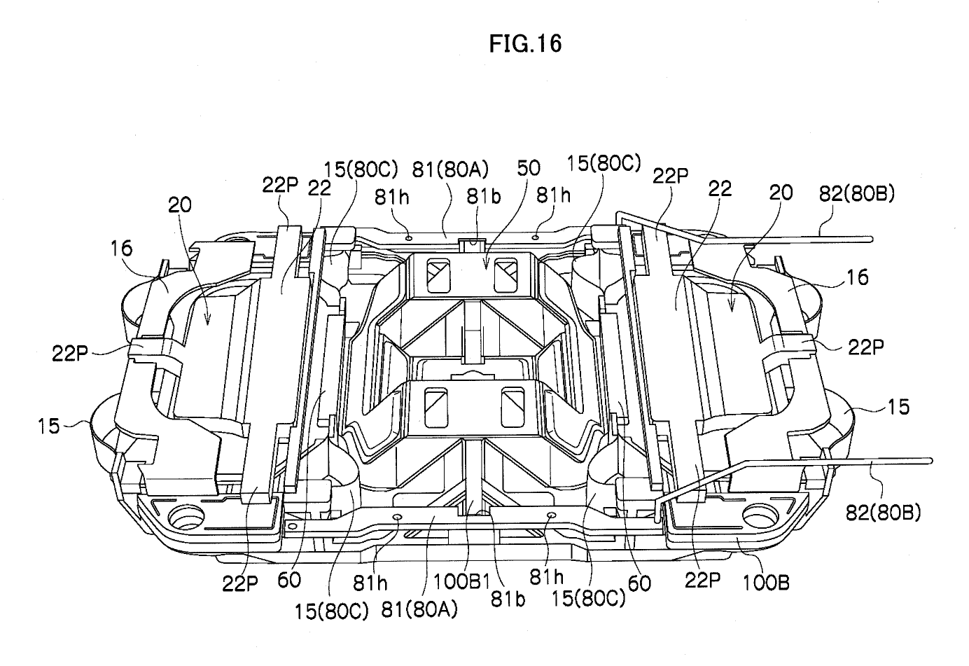

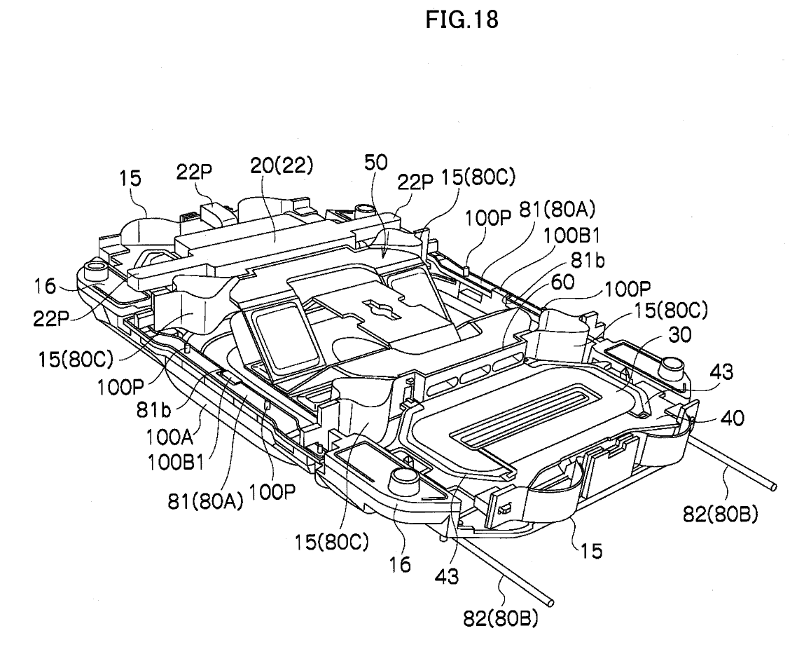

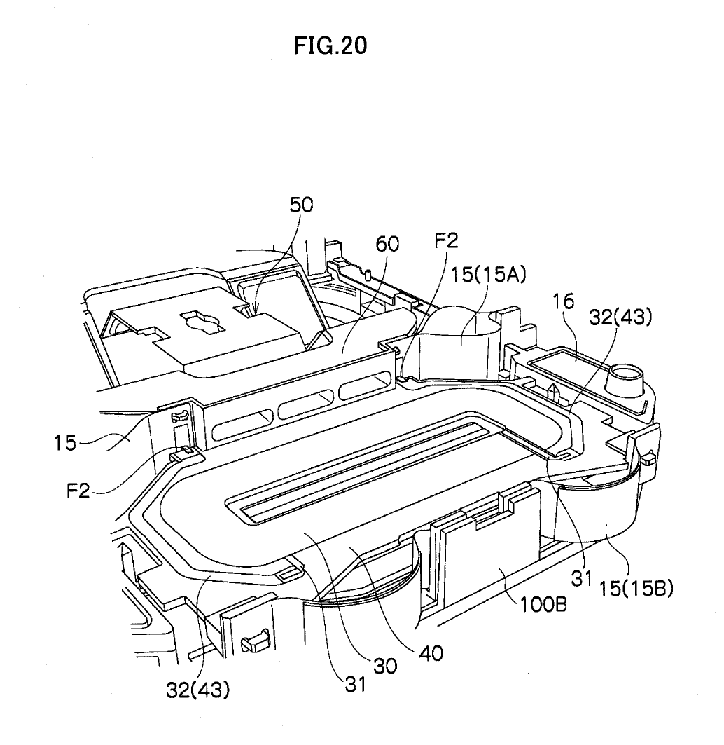

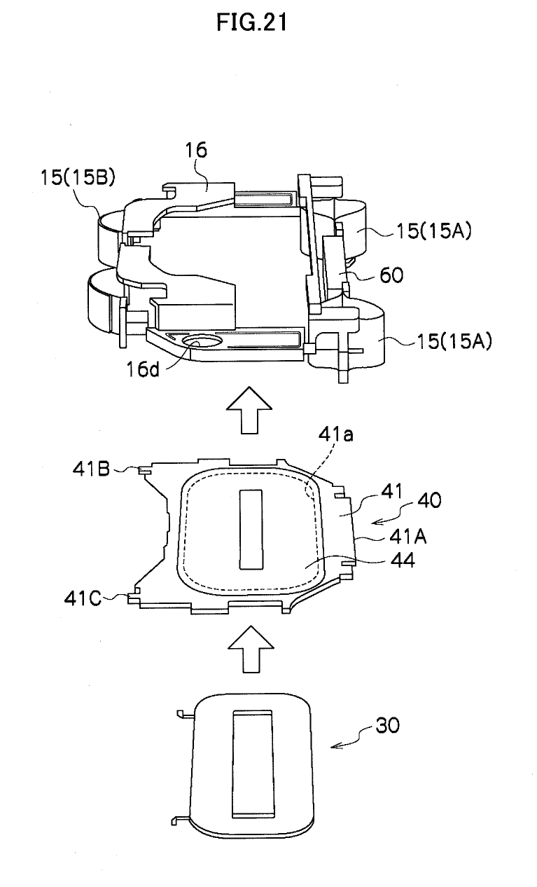

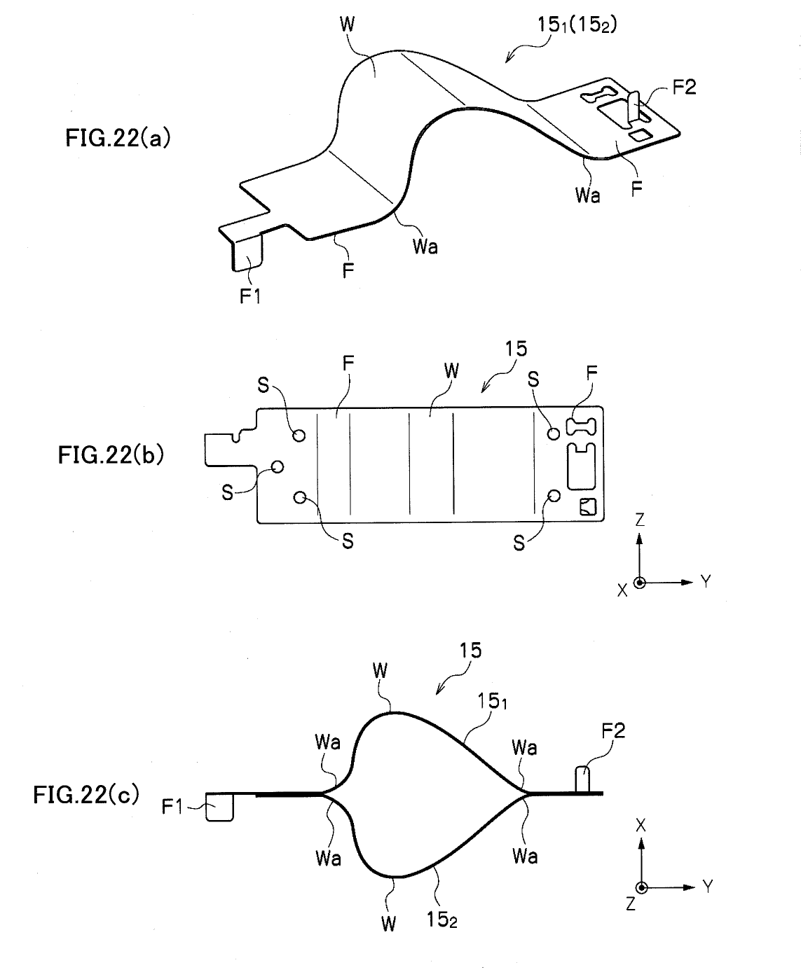

FIG. 16 is a perspective view illustrating an inner structure of the speaker unit (excluding the first configuring member 100A); FIG. 17 is a plan view illustrating an inner structure of the speaker unit (excluding the second configuring member 100B); FIG. 18 is a perspective view illustrating an inner structure of the speaker unit (excluding the second configuring member 100B); FIG. 19 is a perspective view illustrating an inner structure of the speaker unit (illustration of connected state of wiring); FIG. 20 is a partial enlarged view illustrating an inner structure of the speaker unit; FIG. 21 is a view illustrating installation structure of the voice coil; and FIG. 22 is a view illustrating components of the holding part.

The yoke 22 of the magnetic circuit 20 is provided with a projection part 22p to support the yoke 22 at the first configuring member 100A and the second configuring member 100B. The projection part 22p is engaged with a receiving part 105 provided at the first configuring member 100A and the second configuring member 100B.

Either one of the first configuring member 100A and the second configuring member 100B is provided with a positioning pin 100P positioning the terminal parts 81, 81 (see FIGS. 17 and 18) and the terminal part 81 may be arranged at a prescribed position with respect to the static part 100 with the positioning pin 100P inserted into a hole 81h (see FIG. 16) of the terminal parts 81, 81. Further, according to the example shown in the drawings, a concave portion 81b is formed at the side portion of the terminal part 81, 81, and the terminal parts 81, 81 are positioned at the second configuring member 100B with this concave portion 81b engaged with a convex portion 100B1 formed at the second configuring member 100B.

The voice coil 30 is an annular conducting member formed in a tabular shape, and this conducting member is supported by a rigid base (voice coil support part 40). The voice coil 30 or the voice coil support part 40 is unitized by a mounting unit 16 and mounted between the first configuring member 100A and the second configuring member 100B. Further, the voice coil 30 or the voice coil support part 40 is mounted at the mounting unit 16 via the holding part 15, and the voice coil 30 or the voice coil support part 40 is supported by the static part 100 via the holding part 15 with the mounting unit 16 mounted between the first configuring member 100A and the second configuring member 100B. Further, the mounting unit 16 is integrated with the connecting part 60, and the voice coil 30 or the voice coil support part 40 are connected to the vibration direction converter part 50 via the connecting part 60.

A voice coil lead wire 32 (see FIG. 19) connected to a lead wire 31 is formed on the surface of the voice coil support part 40 (base) supporting the voice coil 30. The voice coil lead wire 32 is a conducting layer 43, which is pattern-formed outside of the conducting member of the voice coil 30 so as to surround the conducting member. A pair of the conducting layers 43 are placed such that the voice coil lead wire 32 electrically connects the conducting member of the voice coil 30 and the holding part 15 and functions as a junction wire for inputting the audio signal to the conducting member of the voice coil 30.

A wiring (third wiring 80C), which electrically connects the voice coil 30 and the terminal part 81, is formed on the holding part 15. The end of the terminal parts 81, 81 and the wiring (third wiring 80C) are electrically connected, the wiring (third wiring 80C) of the holding part 15 and the voice coil lead wire 32 are connected, and the wiring 82 (second wiring 80B) is connected to the terminal part 81, 81. Thereby, the audio signal is inputted from outside to the voice coil 30. The wiring (third wiring 80C) may be formed with the holding part 15 as the conducting member. Further, wiring may be separately formed on the holding part 15. Also, the holding part 15 in itself may be formed by using a wiring substrate. Connection between the wiring 82 (second wiring 80B) and the terminal part 81, 81 is made by electrical connection between an end 82a of the wiring 82 and a connecting part 81a of the terminal parts 81, 81.

The holding part 15 has rigidity in a vibration direction of the diaphragm 10 and has a deformable shape in a vibration direction of the voice coil 30. In the example shown in the drawings, the holding part 15 has a side face linearly extending in the vibration direction (X-axis direction) of the diaphragm 10 and has a curved cross-sectional shape in the vibration direction of the voice coil 30. As such, the holding part 15 may restrict the vibration of the voice coil 30 in one axis direction (X-axis direction) and the vibration of the voice coil 30 in other directions is restrained.

The holding part 15, which supports the voice coil 30 at the static part 100 directly or via other member vibratably in the vibration direction of the voice coil 30, has the first holding part 15 (15A) and the second holding part 15 (15B). The first holding part 15 (15A) is arranged on the side of the vibration direction converter part 50 of the voice coil 30, and the second holding part 15 (15B) is arranged on the side opposite to the vibration direction converter part 50 of the voice coil 30.

The first holding part 15 (15A) is arranged on the right and left sides of the connecting part 60 between the connecting part 60 and the static part 100, and the second holding part 15 (15B) is arranged on the right and left sides of the voice coil 30 on the opposite side of coupling to the connecting part 60, and the first holding part 15 (15A) and the second holding part (15B) substantially symmetrically support the voice coil 30 at the static part directly or via other member. More particularly, in the second holding part 15 (15B), the central part thereof is supported by the static part directly or via other member, and both ends thereof are connected to the right and left ends of the voice coil.

FIG. 21 is a view illustrating an attachment structure of the voice coil. The voice coil 30, winding a conducting member, is supported by the voice coil support part 40, and the voice coil support part 40 is supported by the mounting unit 16 via the holding part 15. The voice coil support part 40 includes a voice coil attaching point 41a having an opening in the base 41 made of a tabular insulating material, and one side of the opening is covered with a protection film 44. The voice coil 30 is attached in this voice coil attaching point 41a.

Each of outer ends of a pair of the first holding part 15 (15A) is coupled to the mounting unit 16 on one side of the mounting unit 16, while inner end parts of a pair of the first holding part 15 (15A) are connected to the connecting part 60. The second holding part 15 (15B), a single component, is mounted on the mounting unit on another side of the mounting unit 16, and the central part of this second holding part 15 (15B) is connected to the mounting unit 16 while both ends of the second holding part 15 (15B) are mounted on both ends 41B, 41C of the voice coil support part 40. An end 41a of the voice coil support part 40 is connected to the connecting part 60. The connecting part 60 is a member connecting the voice coil 30 and the vibration direction converter part 50. A connection hole 16d is a fitting hole configured to connect the mounting unit 16 to the static part.

With reference to FIG. 22, a forming example of the holding part 15 is more specifically described. As shown in the drawing, the holding part 15 is formed by joining two configuring members 15₁, 15₂. FIG. 22(a) is a perspective view illustrating a single component of the configuring members 15₁, 15₂, FIG. 22(b) is a side view of the holding part 15, and FIG. 22(c) is its plan view. The configuring members 15₁ (15₂) of the holding part 15, contacting each other at the tabular portion F, have first curved parts W and second curved parts Wa. Tabular portions F, F are provided on both ends, and connecting parts F1, F2 are provided in a direction perpendicular to the tabular portion F. A plurality of configuring members 15₁, 15₂ are conductive metal materials and applied by welding. In one example shown in the drawing, the configuring members 15₁, 15₂ are welded by applying a spot welding to the tabular portion F facing each other. In this example, spot welding is applied to a plurality of points of the tabular portions F, F at both ends (symbols s are spot welding points). Since the holding part 15 is formed with two configuring members 15₁, 15₂ applied each other, the holding part 15 may be prevented from twisting or generating a resonance.

A connecting part F1 to the terminal part 81, 81, which the holding part 15 includes, extends in a direction crossing the vibration direction (Z-axis direction) of the diaphragm 10, and is tabularly formed to contact with the terminal parts 81, 81. Also, a connecting part F2 to the voice coil lead wire 32, which the holding part 15 includes, extends in a direction crossing the vibration direction (Z-axis direction) of the diaphragm 10, and is tabularly formed to contact with the end of the voice coil lead wire 43.

### [Cabinet]

### (Cabinet Configuration Example)

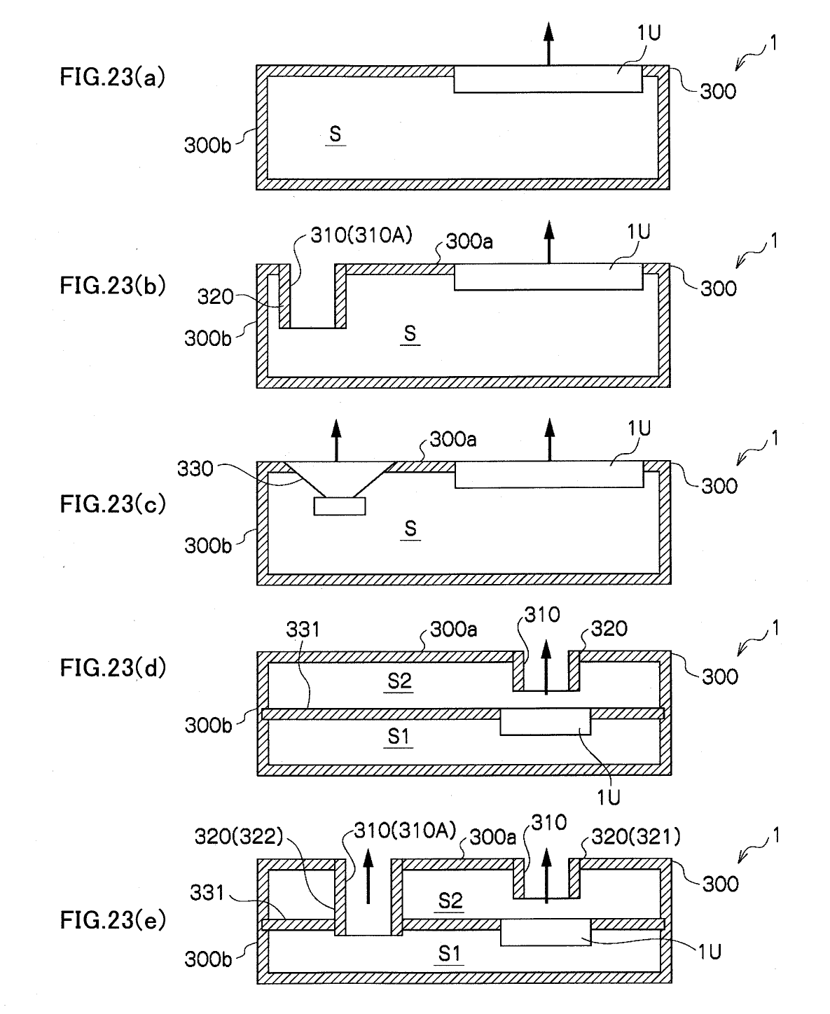

FIGS. 23 to 25 are views illustrating applied to the speaker device according to one embodiment of the present invention. Configurations of a cabinet are not limited to examples shown here.

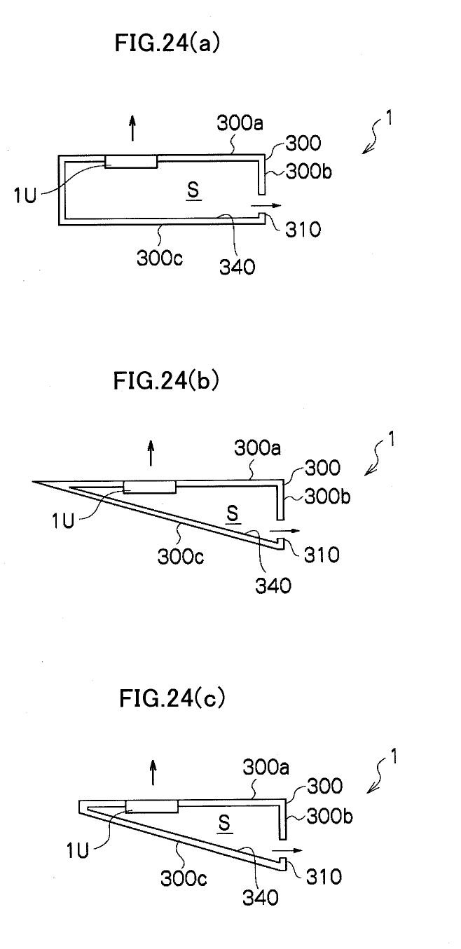

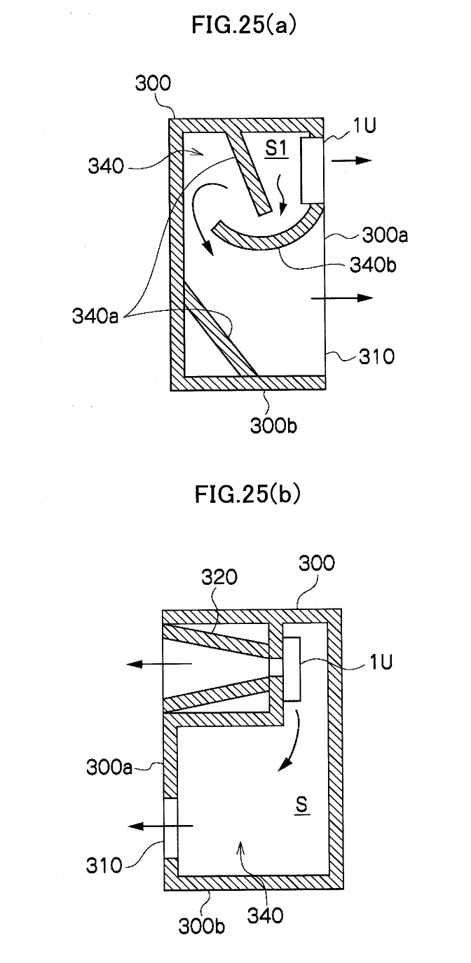

A cabinet 300 of the speaker device 1, according to one embodiment of the present invention, is configured to form a prescribed space S (S1, S2) between the cabinet 300 and a speaker unit S (S1, S2). This space S is basically formed to surround a sound wave emitted from the side opposite to the sound emission side of the diaphragm 10 of the speaker unit 1U, and thereby an acoustic output of the speaker device 1 is prevented from fading due to interference between the sound wave emitted to the opposite side and the sound wave emitted to the sound emission side. The space S surrounded by the speaker unit 1U and the cabinet 300 may be sealed as shown in FIGS. 23(a) and 23(c), or may be opened to outside in part with an opening 310 provided on a front face 300a (sound emission direction side of the speaker unit 1U) or on a side face 300b (other than the sound emission direction side of the speaker unit 1U) of the cabinet 300 as each example shown in FIGS. 23(b), (d), (e), and FIGS. 24 and 25. Further, although not shown, a sound absorbing material may be placed in the cabinet 300 as necessary.

Although the sound wave emitted from the side opposite to the sound emission side of the diaphragm 10 may be securely confined if the space S is sealed, this example may suppress movement of the diaphragm 10 by stiffness of the air with air in the rear of the speaker unit confined and may increase a lowest resonance frequency M of the speaker unit 1U (reproduction band of a low frequency range is limited). However, in the speaker device 1 according to the present invention, a volume of cabinet 300, which does not affect the movement of the diaphragm 10, may be obtained with the speaker unit 1U made thin without forming a large depth in the cabinet 300.

Further in the example of the drawing, although the depth of the cabinet 300 (depth in the vibration direction of diaphragm 10) is formed comparatively large with respect to the thickness (thickness in the vibration direction of diaphragm 1) of the speaker unit 1U, the depth of the cabinet 300 may not be limited to this example and may be formed comparatively small with respect to the thickness of the speaker unit 1U. In this case, the thickness of the speaker device 1 (thickness in the vibration direction of the diaphragm 10) may be further comparatively small, and thus the speaker device 1 may be made thin and small as well.

On the other hand, with the space S opened, it is possible to improve acoustic characteristic by positively making use of the sound wave (rear sound wave) emitted to the side opposite to the sound emission side of the diaphragm 10. To this end, the opening 310 is made as a tubular opening (acoustic port) 310A. In the example shown in FIGS. 23(b) and (e), a sound emitting part 320 communicates between inside and outside of the cabinet 300 and guides to outside the sound wave emitted from the side opposite to the sound emission side of the diaphragm 10. The sound emitting part 320 is provided on a front face 300a or a side face 300b of the cabinet 300. Provided with this sound emitting part 320, a reproducing frequency range in a low frequency range may be widened and a uniform reproducing frequency characteristic may be produced.

In the embodiment shown in FIG. 23(c), a passive diaphragm 330, vibrating corresponding to the drive of the speaker unit 1U, is mounted on or in the cabinet 300 adjacent to the speaker unit 1U. The passive diaphragm 330 (diaphragm provided in a speaker unit having only a vibration system and not a drive system) mounted on the front face 300a of the cabinet 300 instead of the above-mentioned tubular opening (acoustic port) 310A. This may also makes it possible to improve a reproducing frequency characteristic as in the above-mentioned embodiment.

In the embodiment shown in FIGS. 23(d) and 23(e), the cabinet 300 has a wall portion 331 partitioning the inside space into a first space S1 and a second space S2, and the speaker unit 1U is mounted on this wall portion 331 such that a part of the speaker unit 1U is arranged in the first space S1. In the embodiment shown in FIG. 23 (d), the sound emitting part 320, communicating the second space S2 with outside and emitting the sound wave of the speaker unit 1U, is provided on the front face 300a or the side face 300b of the cabinet 300. In the embodiment shown in FIG. 23 (d), the rear side of the speaker unit 1U forming the first space S1 is sealed, and with the second space S2 and the sound emitting part 320 provided on the front face of the diaphragm of the speaker unit 1U, it is possible to improve the above-mentioned reproducing frequency characteristic while using advantage of sealed structure. Further, since the rear side of the speaker unit 1U forming the first space S1 is sealed, reproduction frequency in a prescribed reproducing frequency range has a bandpass characteristic, and thus frequency characteristic of output sound pressure in the frequency range may be improved.

In the embodiment as shown in FIG. 23(e), the cabinet 300 has the wall portion 331 partitioning the inside space into the first space S1 and the second space S2. The speaker unit 1U is mounted on this wall portion 331 such that a part of the speaker unit 1U is arranged in the first space S1. The second space S2 is disposed in the opposite side of the speaker unit 1U. The first sound emitting part 320 (321) guiding outside the sound wave which the speaker unit 1U emits in the side of the second space S2 and the second sound emitting part 320 (322) guiding outside the sound wave the speaker unit 1U emits in the side of the first space S1 are provided on the front face 300a or the side face 300b of the cabinet 300. The second sound emitting part 322 has a tubular shape, which extends from outside to the space S1 passing through the second space S2 and the wall portion 331. This example is configured to add an advantage of emitting the rear sound wave by using the sound emitting part 320 (322) to the example shown in FIG. 23 (d).

In the embodiments shown in FIGS. 24 and 25, an opening 310 is formed on the front face 300a or the side face 300b of the cabinet 300, while an acoustic tube 340 is formed in a cabinet guiding a sound wave emitted from the side opposite to the sound emission side of the diaphragm 10 outside. The acoustic tube 340 is configured to make low frequency sound reproduction using resonance phenomenon of sound guided through a tube. In the example shown in FIG. 24, the acoustic tube 340 is formed with the length of the cabinet 300, and the example shown in FIG. 24(a) has a fixed cross-section, while the examples shown in FIGS. 24(b) and 24(c) have a tapered face of a bottom face 300c of the cabinet 300.

In the embodiment shown in FIG. 25(a), a sound wave emitted from the front surface of the speaker unit 1U is emitted outside as it is, and a sound wave emitted from the rear side of the diaphragm 10 is guided to the front face 300a of the cabinet 300 through the acoustic tube 340 formed in the cabinet 300, and thus an efficient low frequency sound reproduction is produced. The acoustic tube 340 may be configured with a straight portion 340a and a curved portion 340b.

The embodiment shown in FIG. 25(b) is configured to combine the embodiment shown in FIG. 25(a) and a cabinet, so-called a front loading horn type. A characteristic of low frequency sound reproduction may be improved by the acoustic tube 340 guiding the rear sound wave, and a characteristic of mid-high frequency range may be improved by the sound emitting part 320 guiding the sound wave emitted directly from the sound emission side of the speaker unit 1U.

### (Example of Speaker Unit Arrangement in Cabinet)

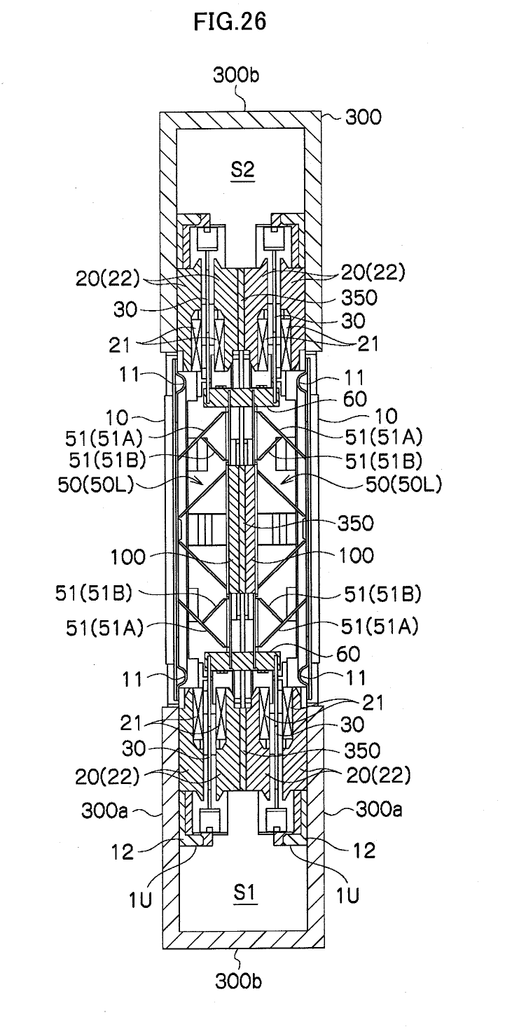

FIGS. 26 to 30 are views illustrating the embodiments of speaker unit arrangement in a cabinet. In the embodiments, a plurality of diaphragms 10 disposed opposite to each other are driven by a plurality of speaker units 1U, 1U or a single speaker unit 1U.

In the embodiment shown in FIG. 26, a plurality of the speaker units 1U are provided. And the plurality of speaker units 1U are mounted opposite to each other on the outer periphery face of the cabinet 300 with the sound emission surfaces of the speaker units facing different directions from each other. And the sound emission surfaces of the speaker units 1U are provided facing outside. In the example shown in the drawing, two speaker units 1U are arranged opposite to each other and each of their static parts 100, 100 is connected to each other directly or via other member, and thus a thin both-face-emission type speaker device is configured. In this configuration, when two speaker units 1 are driven by a single audio signal, vibrations, transmitted to both speaker units 1U, 1U when driving, cancel each other, and thereby a stable drive may be realized. In the speaker unit 1U that can be made thin as described above, even if two diaphragms are applied opposite to each other, the thickness of the speaker device is not much increased. With the space S1 and S2 formed in the side of the speaker units 1U, 1U in the cabinet 300, a speaker device including a cabinet 300 with a small depth (thickness) may be produced. Despite the cabinet 300 with a small depth (thickness), the volume of the space S1 and S2 can be sufficiently secured by using the space in the side of the speaker unit 1U, 1U, and thus the vibration of the diaphragm 10 may not be restrained by air stiffness in the cabinet 300 even when forming the sealed cabinet 300.

Further, in this configuration, a vibration restraining member 350 may be provided between the speaker units 1U, 1U. According to this configuration, vibrations affecting each other between the speaker units 1U, 1U are absorbed by the vibration restraining member 350, and thereby more stable drive of the speaker device may be achieved.

Further, in this embodiment, vibration direction converter part 50, as described above, has a link part 51 as the first link part 51A. The vibration direction converter part 50 also has the second link part 51B as the link body 50L between the first link part 51A and the static part 100. The above-mentioned vibration restraining member 350 is mounted on a part of the static part 100 supporting the second link part 51B. In this embodiment, since the vibration restraining member 350 is mounted between the static parts 100, 100 supporting both link bodies 50L, 50L, it is possible to restrain the trouble that vibrations of the vibration direction converter part 50 affect each other causing an unstable drive of the speaker device or generating abnormal noises when driving the speaker device. Further, when the above-mentioned mechanical impedances are substantially the same, a reaction force which each link part of the vibration direction converter part 50 received from the diaphragm 10 may be canceled each other. In the operation in itself of the vibration direction converter part 50, with the static parts 100, 100 supporting both vibration direction converter parts 50, 50 contacted with each other directly or via other member, position fluctuation of the static part 100, 100 may hardly occur, and thereby stable vibration direction conversion may be achieved.

Further, the above-mentioned vibration restraining member 350 mounted between the static parts 100, 100 has flexibility or comparatively large compliance. Also, the vibration restraining member 350 has high-cut function shutting off a vibration prescribed as high frequency vibrations that voice coil 30 transmits to the diaphragm 10 via the vibration direction converter part 50. Thus, it is possible to restrain the trouble that vibration of the vibration direction converter part 50 causes resonance in the static part 100 or reproduced sound-pressure frequency characteristic of the speaker unit 1U is fluctuated or harmonic distortion is generated.

Further, as the example shown in the drawing, the connecting parts 60, 60 that the speaker unit 1U, 1U include may be connected directly or via the vibration restraining member 350. When the connecting parts 60, 60 are connected directly or via other member, generation of unwanted vibrations may be restrained, and thus acoustic characteristic may be improved.

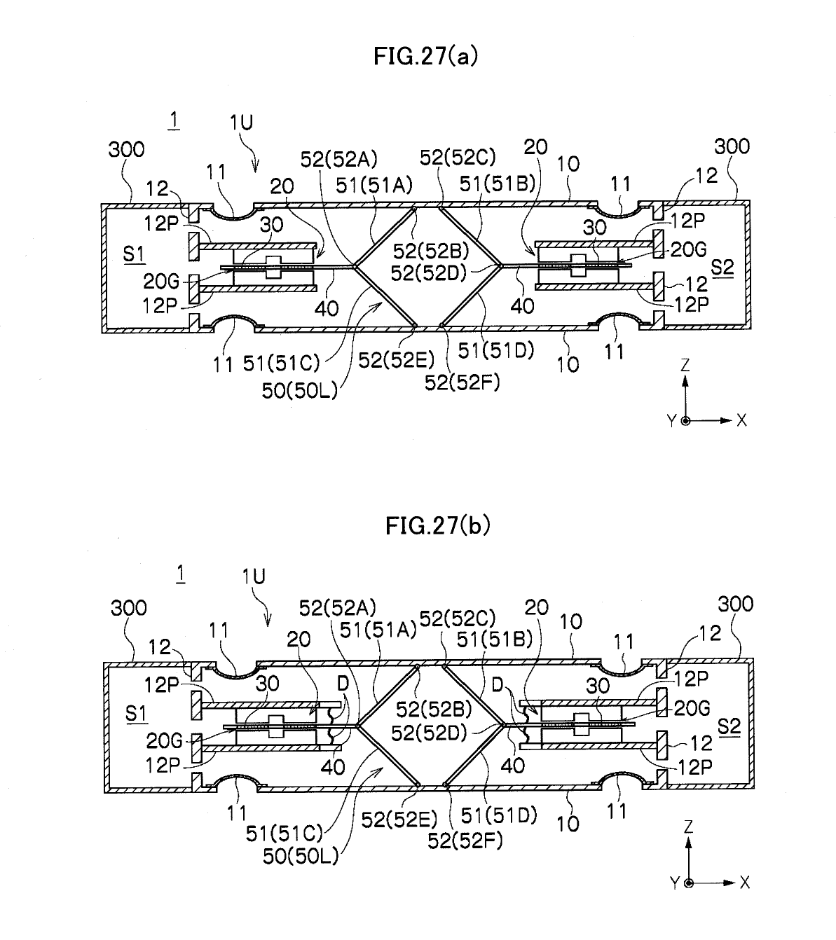

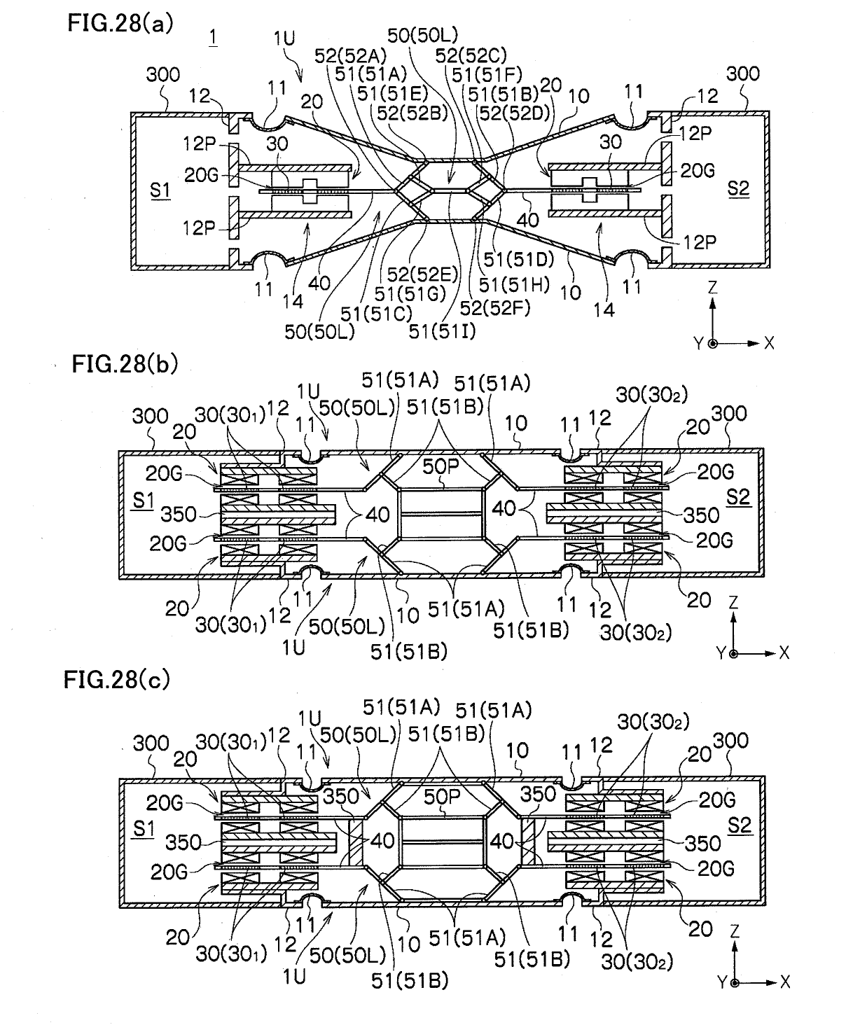

FIGS. 27 and 28 show embodiments that the speaker unit 1U, which vibrates a pair of the diaphragms 10, 10 with the link body 50L of various types of vibration direction converter parts 50, is mounted on or in the cabinet 300. In the embodiment shown in FIG. 27, vibrations of the voice coils 30 (30₁, 30₂) supported vibratably in the X-axis direction, moving closer or away each other, are direction-converted by the vibration direction converter part 50 that includes the link body 50L having the link parts 51 (51A, 51B, 51C, 51D) and the hinge parts 52 (52A, 52B, 52C, 52D, 52E, 52F) and drive a pair of the diaphragm 10, 10. The voice coil 30 (30₁, 30₂) is arranged in the magnetic gap 20G of the magnetic circuit 20, which is attached to the attaching portion 12p of the frame 12. Space S1, S2 in the cabinet 300 is formed at the side portion of the frame 12. In FIG. 27(a), the voice coil 30 is supported only by holding part (not shown), and in FIG. 27(b), the move of the voice coils is restricted by the damper D in addition to the holding part.

The embodiment shown in FIG. 28(a) is the same as the embodiment shown in FIG. 27(a) except that the link part 51 includes link part 51E, 51F, 51G, 51H and 511 in addition to the above-mentioned example shown in FIG. 27(a) and the central part of the diaphragm 10 has a concave portion. The embodiment, shown in FIGS. 28(b) and 28(c), includes two voice coils 30₁, 30₁ vibrating substantially in the same direction and two voice coils 30₂, 30₂ vibrating substantially in the same direction, moving near and away the two voice coils 30₁, 30₁, and in the vibration direction converter part 50 the link body having the first link part 51A and the second link part 51B is supported by four corners of a rectangular fixing frame 50P. The voice coil 30 (30₁, 30₁, 30₂, 30₂) is arranged in the magnetic gap 20G of the corresponding magnetic circuit 20. And, a magnetic circuit 20 arranged in proximity connects via the vibration restraining member 350.

In the embodiments shown in FIGS. 27 and 28, the vibration direction converter part 50 that vibrates a pair of the diaphragm 10, 10 is substantially symmetrically arranged with respect to a central axis in the vibration direction of the voice coil 30. As such, the link part 51 of the link body 50L is substantially symmetrically vibrated with respect to the above-mentioned central axis, and thus interference between each link part 51 may be canceled. Accordingly, the trouble such as resonance phenomenon caused by the vibration of the vibration direction converter part 50 may be restrained.

In the embodiments shown in FIGS. 27 and 28, when the interval of the speaker units 1U, 1U, particularly the interval of the diaphragms 10, 10 is comparatively small, the speaker unit 1U, 1U can be deemed as a point sound source in a frequency range of comparatively long wavelength (comparatively low frequency). Thus, output sound pressure characteristic in a low frequency range is not affected to an area of a baffle board (area of a part of cabinet 300 supporting and surrounding the diaphragms 10, 10), and thus the speaker device 1 may preferably produce the reproduced sound in the low frequency range. Further, with the comparatively downsized cabinet 300, the speaker device 1 may produce the reproduced sound in a sufficiently low frequency range.

Further, with the substantially same mechanical impedances as mentioned above, reaction force to each link part of the vibration direction converter part 50, received from the diaphragm 10, may be canceled.

Further, as in FIG. 26, the voice coil 30, included in the speaker units 1U, 1U may be connected to the voice coil support part 40 directly or via the vibration restraining member 350 as shown in FIG. 28(c). When the connecting parts 60, 60 are connected directly or via other member, generation of unwanted vibration may be restrained, and acoustic characteristic may be improved.

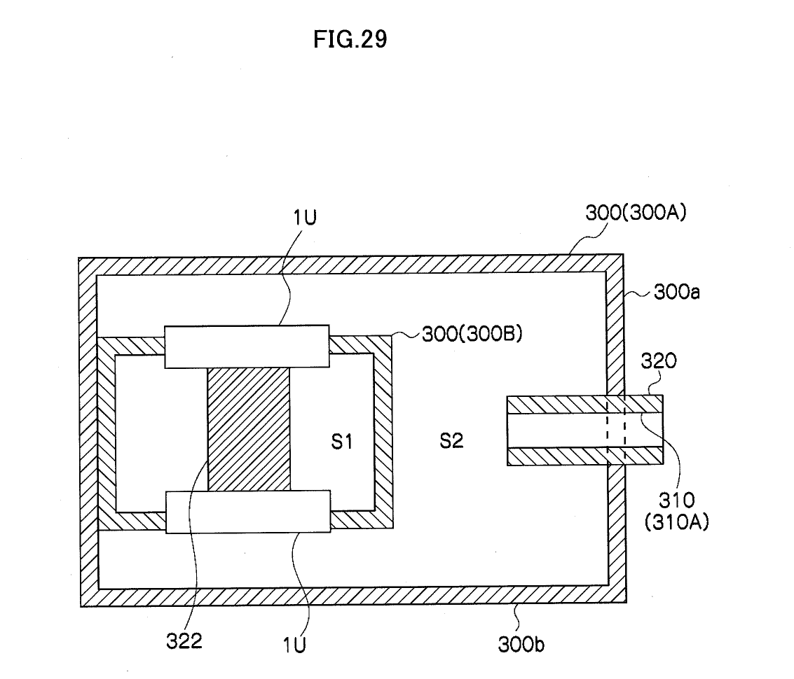

In the embodiment shown in FIG. 29, the cabinet 300 is a first cabinet 300 A. A second cabinet 300B is provided inside the first cabinet 300A. In the second cabinet 300B, a plurality of the speaker units 1U, 1U are mounted with their sound emission directions positioned opposite to each other, and the sound emitting part 320 communicating the space between the first cabinet 300A and the second cabinet 300B with outside and guiding outside the sound wave of the speaker unit 1U, 1U is provided on the front face 300a or the side face 300b of the first cabinet 300A. Further, in the example shown in the drawing, a support pole 322 is placed between a plurality of speaker units 1U, 1U.

In this embodiment, with two speaker units 1U disposed opposite to each other, interference caused by vibration of each other is canceled as described above, and thus a stable drive of the speaker unit 1U, 1U may be achieved. Further, in this embodiment, a function of the cabinet 300 as shown in FIG. 23(d) may be produced. As such, it is possible to confine the rear sound wave of the speaker unit 1U, 1U and improve the reproducing frequency characteristic with the sound emitting part 320 arranged.

In the embodiments described with reference to FIGS. 26 to 29, when mechanical impedances of the vibration direction converter parts 50, 50 of the speaker unit 1U are substantially the same with each other, mechanical impedances of the diaphragm 10, 10 of the speaker unit 1U are substantially the same with each other, mechanical impedances of edge 11, 11 of the speaker unit 1U are substantially the same with each other and mechanical impedances of the holding part 15 (not shown) of the speaker unit 1U are substantially the same with each other, it is possible to drive two speaker units 1U keeping a good balance.

For example, it is preferable that the vibration direction converter parts 50, 50, the diaphragms 10, 10 and the edges 11, 11 substantially have the same weight with each other, the holding part 15 substantially have the same compliance and each link part of the vibration direction converter substantially have the same rigidity or compliance (mechanical resistance).

Further, when mechanical impedances are significantly different, each speaker unit may not be preferably driven and unwanted vibration may be generated at the speaker units 1U, 1U.

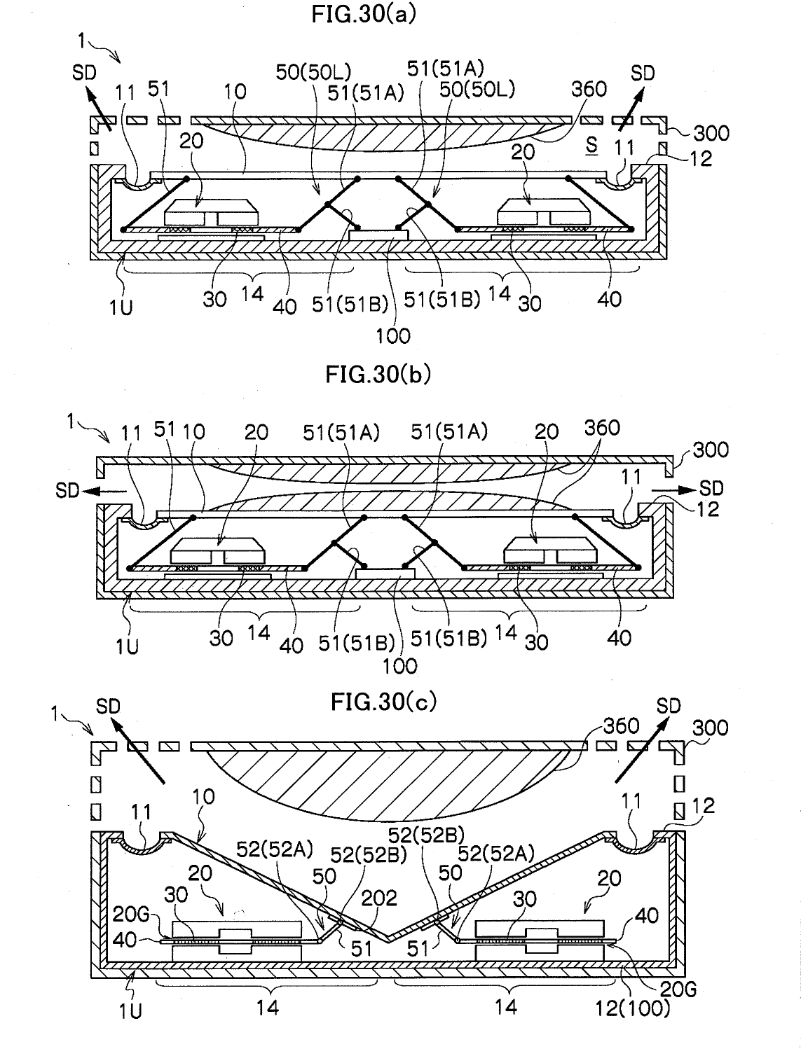

The embodiment shown in FIG. 30 is one example in which a sound reflection member (equalizer), reflecting a sound wave, is provided on the sound emission side of the speaker unit 1U (SD shows a sound emission direction). In the embodiment shown here, the link part 51 has one end angle-variably connected to the voice coil 30 directly or via other member, while another end part angle-variably connected to the diaphragm 10 directly or via other member. The vibration of the voice coil 30 is transmitted to the diaphragm 10 via the direction converter part 50 including the link part 51 obliquely disposed with respect to the vibration direction of the diaphragm 10 and the vibration direction of the voice coil 30 respectively. In the embodiments shown in FIGS. 30(a) and (b), the driving parts 14, 14 having a pair of the voice coils 30, 30 drive the tabular diaphragm 10, while in the embodiment shown in FIG. 30(c), a pair of the driving parts 14, 14 drive the diaphragm 10 formed in a V-shape cross-section (cone shape). A diaphragm, formed in a curved and convex or curved and concave cross-sectional shape (dome shape), may be driven in place of the above diaphragm 10.

In the embodiments shown in FIGS. 30(a) to 30(c), the speaker unit 1U is arranged in the cabinet 300 and the sound reflection member 360 is provided on the sound emission side of the diaphragm 10. In the embodiments shown in FIGS. 30(a) to 30(c), the sound reflection member 360 is provided on the inner face of the cabinet 300 facing diaphragm 10, and in the embodiment shown in FIGS. 30(b), the sound reflection members 360 are provided on the face of the sound emission side of the diaphragm 10 and on the inner face of the cabinet 300 facing the face of the sound emission side.

In any embodiments, a prescribed interval is provided extending from the central part to the periphery part of the diaphragm 10 between the diaphragm 10 and the sound reflection member 360 of the speaker unit 1U. Further, in the embodiments shown in the drawings, the distance between the diaphragm 10 and the sound reflection member 360 of the speaker unit 1U is configured to increase from the central part to the periphery part of the diaphragm 10. Provided with this sound reflection member 360, the sound emitted from the diaphragm 10 may be reflected at the sound reflection member 360 and diffused around the speaker device, and almost omnidirectional emission property may be obtained.

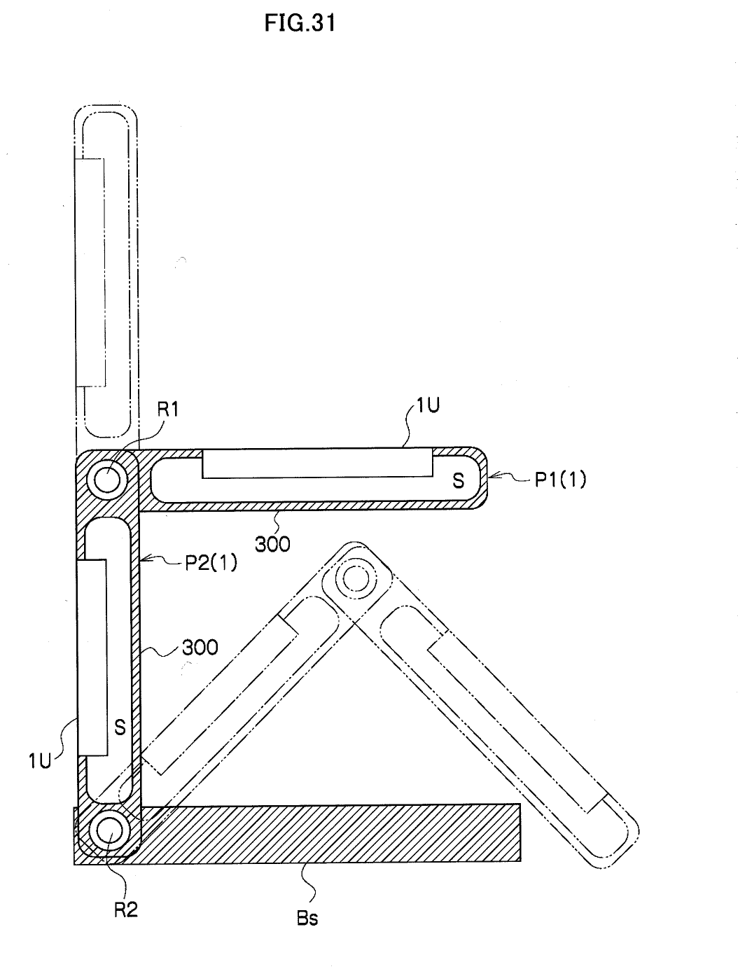

FIG. 31 shows an embodiment of the speaker device 1 including the cabinet 300. In this embodiment, a first panel P1 including a first speaker device 1 in which the speaker unit 1U is mounted on or in the cabinet 300 and a second panel P2 including a second speaker device 1 in which the speaker unit 1U is mounted on or in the cabinet 300 are rotatably coupled to each other at their side portions. In this embodiment, one side portion of the first panel P1 is connected to one side portion of the first panel P2 via a rotational axis R1, and another end of the second panel P2 is rotatably connected to one end of a base board Bs via a rotational axis R2. According to this speaker device, the panels P1 and P2 may change an angle therebetween corresponding to usage, and thus the speaker unit 1U may direct its sound emission direction in a given direction. The speaker unit 1U, mounted on or in the cabinet 300, may confine the rear sound wave of the speaker unit 1U to the space S inside the cabinet 300. Further, a speaker unit for mid-high-frequency range may be used in place of the speaker unit 1U mounted on or in the panel P1 or P2. In this case, reproduced sound may be produced in full range. Further, when a speaker unit for mid-high-frequency range is mounted on or in the panel P1 or P2, the panel P1 and the panel P2 may be arranged substantially orthogonally to the base board Bs. This embodiment may be applied to various types of electronic devices including the speaker unit 1U.

### Mounting Embodiments

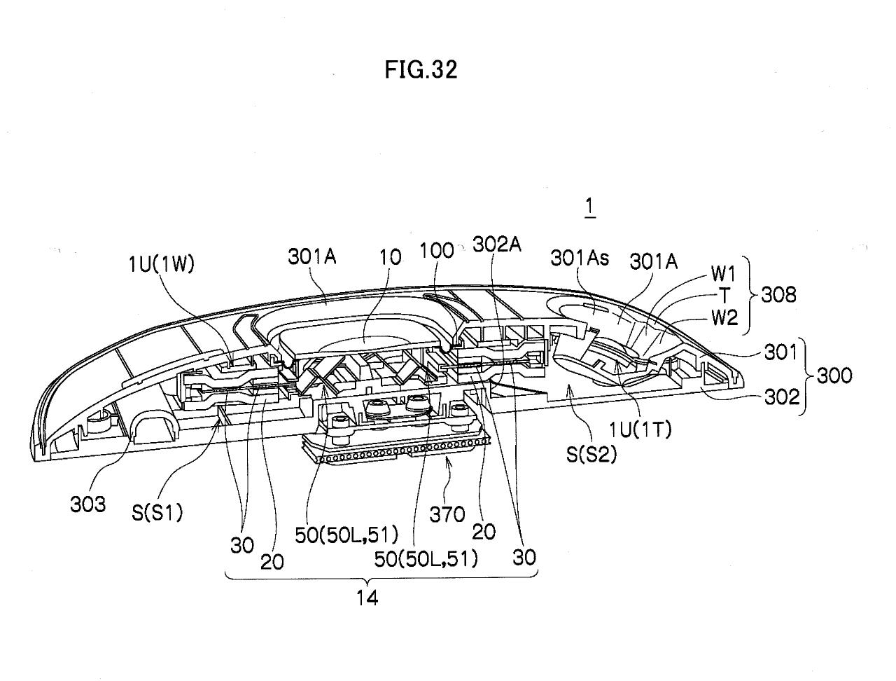

FIG. 32 is a cross-sectional perspective view illustrating the whole configuration of the speaker device according to one embodiment of the present invention. The speaker device 1 includes the speaker unit 1U and the cabinet 300 mounted to the speaker unit 1U. The cabinet 300 is formed with a lid 301 and a housing part 302. Space S (S1, S2) is formed between the lid 301 and the housing part 302 by joining their peripheries.

In the cabinet 300, a speaker unit 1W for low frequency range adopting the above speaker unit 1U and a speaker unit 1T for mid-high-frequency range adopting small size speaker unit are arranged. The lid 301 has two openings 301A. At each opening 301A, the diaphragms 10 of each speaker unit 1T and 1W is opened. Further, a diffusing part 308 is formed in an inner wall part 301As in proximity of the opening 301A corresponding to the speaker unit 1T for mid-high-frequency range. The diffusing part 308 may emit sound emitted from the diaphragm 10 in a different direction. The diffusing part 308 has a top T formed with two opposing curved parts W1 and W2 crossing each other. The top T is formed from the inner periphery part to the outer periphery part of the wall part 301As. As such, it is possible to diffuse-emit in a predetermined area the sound emitted from the speaker unit 1T for high frequency range reproduction, which has a comparatively high directional characteristic.

The space S in the cabinet 300 has the first space S1 and the second space S2 on both sides of the vibration direction converter part 30. The magnetic circuit 20 and the voice coil 30 are arranged in each space S1 and S2. A part of the vibration direction converter part 50 is supported on a convex portion 302A, such that the convex portion 302A is formed with a bottom face of the housing part 302 projected inside. Further, an attachment part 370 is placed in a concave portion that is a rear side of the convex portion 302A and the speaker device 1 including the cabinet 300 is attached to an attaching counterpart Tr by the attachment part 370. A duct 303 is provided in the space S. The end of the duct is coupled to an opening of the housing part 302. The attaching counterpart Tr may include, for example, automobile trim or support frame of an electronic device.

According to the speaker device 1 configured as above, since the vibration of the voice coil 30 is direction converted by the vibration direction converter part 50 and transmitted to the diaphragm 10, amplitude of vibration of voice coil 30, even though it is increased, will not directly affect thickness in the sound emission direction of the speaker device 1. Accordingly, the speaker device 1 may be made thin while enabling to make louder sound. Further, since generated sound with opposite phase is captured in the space of the cabinet 300, generated sound from the diaphragm 10 is not damped, and thereby efficient acoustic reproduction may be achievable. More particularly, since the link body 50L of the vibration direction converter part 50 may be firmly supported by a part of the cabinet 300, angle conversion of the link part 51 may be efficiently achieved by reaction force from the cabinet 300, and thus the vibration of the voice coil 30 may be efficiently transmitted to the diaphragm 10 while making direction conversion.

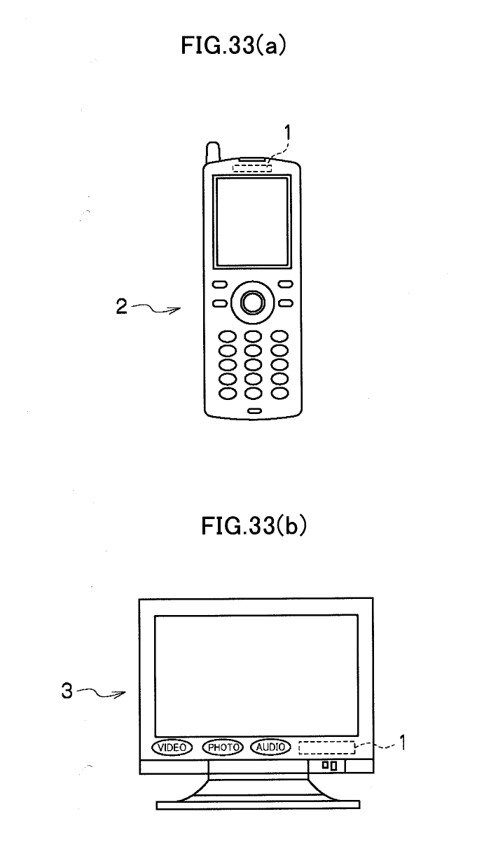

This speaker device can be efficiently used as various types of electronic devices or in-car devices. FIG. 33 is a view illustrating an electronic device including a speaker device according to one embodiment of the present invention. An electronic device 2 such as a mobile phone or a handheld terminal shown in FIG. 33(a) or an electronic device 3 such as a flat panel display shown in FIG. 33(b) has a housing as the above attaching counterpart in which the speaker device 1 is housed. The speaker device 1 may also be attached to the side face of the housing as the attaching counterpart of the electronic device. Since installation space in thickness direction required for the speaker device 1 may be decreased, the whole electronic device may be made thin. Further, sufficient audio output may be produced even by the electronic device made thin.

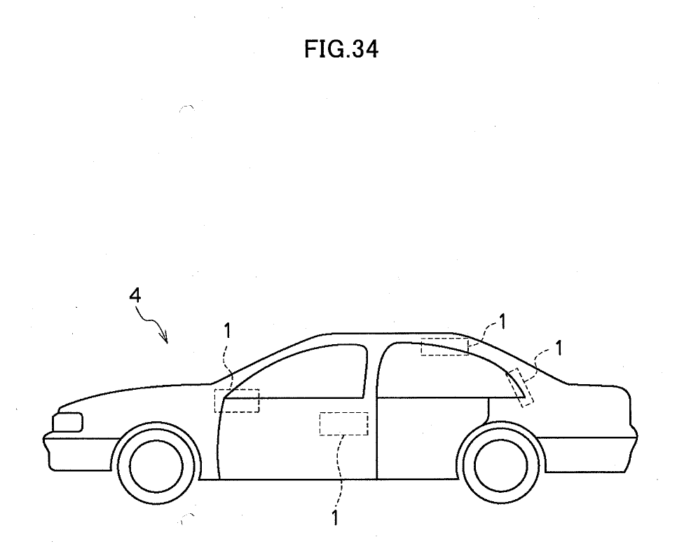

FIG. 34 is a view illustrating an automobile provided with a speaker according to one embodiment of the present invention. In an automobile 4 shown in FIG. 34, in-car space may be widened with the speaker device 1 made thin. More particularly, the speaker device 1 according to the embodiment of the present invention, even if attached to a door panel, ceiling, rear tray or a dashboard as the attaching counterpart, may comparatively reduce a bulge projecting into in-car space, and thus enabling to widen driver's space or in-car space. Further, with sufficiently produced audio output, it is possible to enjoy listening to music or radio broadcasting pleasantly in a car even when driving in a high speed with much noise. The electronic device according to the embodiment as shown in FIG. 31 may be attached to the attaching counterpart such as a dashboard, etc. in an automobile, and thus a desirable acoustic field may be created in accordance with the number of passengers or seating positions in the automobile.

Further in a resident building, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Other examples of the application of the speaker device 1 are described hereinafter. The speaker device 1 can be effectively applied to sound reproduction means for announcing to a user operating condition of home appliance such as a refrigerator, washing machine, control panel of water heater in bath room, microwave oven, air conditioner, watch, rice cooker, oil fan heater, etc. It also can be effectively applied to an acoustic generation element for dramatic impact of amusement machine such as a pachinko, slot panel or entertainment device, and a headphone, earphone, hearing aid, music instrument speaker, speaker for amplifying a sound, speaker for studio, speaker for a hall, speaker for karaoke, etc.

Further, the speaker device 1, used in road noise reduction system as shutting off body of shutting off external sound, also can be attached to the predetermined attaching counterpart such as wall surface of roads. Moreover, the speaker device 1 may be effectively used as a vibration generation device and a body sensory actuator (body sonic, etc.).

Although the embodiments according to the present invention are described with reference to the drawings, specific configurations are not limited to these embodiments, and modifications not departing from the subject matter of the present invention are included in the scope of the present invention. Further, the technology of each embodiment described above can be used by each other, unless specific contradictions or problems are found in their objects, the configurations, etc. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009, PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, PCT/JP2009/055528 filed on Mar. 19, 2009, PCT/JP2009/62482 filed on Jul. 9, 2009, PCT/JP2009/62483 filed on Jul. 9, 2009, PCT/JP2009/62484 filed on Jul. 9, 2009, PCT/JP2009/62477 filed on Jul. 9, 2009, PCT/JP2009/62478 filed on Jul. 9, 2009, PCT/JP2009/62479 filed on Jul. 9, 2009, PCT/JP2009/62480 filed on Jul. 9, 2009 and PCT/JP2009/62481 filed on Jul. 9, 2009 are incorporated by reference into the present application.

1. A speaker device comprising:
a speaker unit and
a cabinet on or in which the speaker unit is mounted, wherein
said speaker unit includes:
a diaphragm,
a static part supporting the diaphragm vibratably in a vibration direction, and
a driving part provided at the static part to vibrate said diaphragm in response to an audio signal,
said driving part includes:
a magnetic circuit forming a magnetic gap,
a voice coil vibrating in a direction different from the vibration direction of said diaphragm upon the inputted audio signal, and
a rigid vibration direction converter part configured to convert the vibration direction of said voice coil and transmit the vibration to said diaphragm,
said rigid vibration direction converter part is arranged such that one end is angle-variably coupled to said voice coil while another end is angle-variably coupled to said diaphragm, said vibration direction converter part being obliquely disposed with respect to the vibration direction of said diaphragm and the vibration direction of said voice coil respectively, and
said cabinet is configured to form a prescribed space between the cabinet and said speaker unit.

2. A speaker device comprising:
a speaker unit and
a cabinet on or in which the speaker unit is mounted, wherein
said speaker unit includes:
a diaphragm,
a static part supporting the diaphragm vibratably in a vibration direction., and
a driving part provided at the static part to vibrate said diaphragm in response to an audio signal,
said driving part includes:
a magnetic circuit forming a magnetic gap in a direction different from the vibration direction of said diaphragm,
a voice coil vibrating along said magnetic gap, and
a vibration direction converter part configured to convert a vibration direction of said voice coil and transmit the vibration to said diaphragm,
said vibration direction converter part includes a link body configured to angle convert a link part formed between said voice coil and said diaphragm, and
said cabinet is configured to form a prescribed space between the cabinet and said speaker unit.

3. The speaker device according to claim 1, wherein the space enclosed by said speaker unit and said cabinet is sealed.

4. The speaker device according to claim 1, wherein a sound emitting part, which is arranged such that inside and outside of said cabinet communicate with each other and guide to outside of the cabinet a sound wave emitted from a side opposite to a sound emission side of said diaphragm, is provided at a front face or on a side face of said cabinet.

5. The speaker device according to claim 4, wherein the front face or the side face of said cabinet includes an opening configured to enable inside and outside of said cabinet to communicate with each other.

6. The speaker device according to claim 1, wherein a passive diaphragm vibrating with said speaker unit is mounted on or in said cabinet adjacently to said speaker unit.

7. The speaker device according to claim 1, wherein
said cabinet includes a wall portion partitioning a space inside the cabinet into a first space and a second space,
a part of said speaker unit being mounted at said wall portion is arranged in said first space, and
a sound emitting part, which enables said second space to communicate with outside to emit a sound wave of said speaker unit, is provided at a front face or on a side face of said cabinet.

8. The speaker device according to claim 1, wherein
said cabinet includes a wall portion partitioning a space inside the cabinet into a first space and a second space,
a part of said speaker unit being mounted at said wall portion is arranged in said first space,
said second space is disposed on a side opposite to said speaker unit, and
a first sound emitting part guiding to outside of the cabinet a sound wave that said speaker unit emits on a side of said second space and a second sound emitting part guiding to outside of the cabinet a sound wave that said speaker unit emits on a side of said first space are provided at a front face or on a side face of said cabinet.

9. (canceled)

10. The speaker device according to claim 1, wherein
said cabinet is a first cabinet,
a second cabinet is provided inside said first cabinet,
a plurality of speaker units are mounted on or in said second cabinet such that the sound emission directions are opposite to each other, and
a sound emitting part, communicating a space between said first cabinet and said second cabinet with outside and guiding sound waves of said speaker units to outside, is provided at a front face or on a side face of said first cabinet.

11-13. (canceled)

14. The speaker device according to claim 1, further comprising a plurality of speaker units, wherein
said speaker units, positioned opposite to each other, are mounted on or in an outer periphery surface of said cabinet,
sound emission surfaces of said speaker units are directed toward different directions from each other, and
the sound emission surfaces of said speaker units face outside of the cabinet.

15. The speaker device according to claim 14, wherein a vibration restraining member is provided between said speaker units.

16-17. (canceled)

18. An electronic device, comprising:
the speaker device according to claim 1,
a second speaker device,
a first panel including said first speaker device, and
a second panel including a second speaker device, wherein
the first panel and the second panel are rotatably connected at side portions with each other.

19. (canceled)

20. An automobile comprising an attachment counterpart, wherein the speaker device according to claim 1 is mounted on or in said attaching counterpart.

21-22. (canceled)

23. An electronic device comprising an attaching counterpart, wherein the speaker device according to claim 1 is mounted on or in said attaching counterpart.

24. A building comprising an attaching counterpart, wherein the speaker device according to claim 1 is mounted on or in said attaching counterpart.

25-30. (canceled)

31. The speaker device according to claim 1, further comprising:
a connecting part located between an end of said vibration direction converter part on a side of said voice coil and an end of said voice coil on a side of said vibration direction converter part, wherein
said connecting part connects said voice coil and said vibration direction converter part with both said ends being different positions in said vibration direction of said diaphragm.

32. The speaker device according to claim 1, wherein
said vibration direction converter part connects to an attaching counterpart including said diaphragm and said voice coil, and includes a hinge part in proximity of the attaching counterpart, and
a contact avoiding part avoiding contact with said hinge part is formed on a surface side of said attaching counterpart in proximity of said hinge part.

33. The speaker device according to claim 1, wherein
said vibration direction converter part connects to an attaching counterpart including said diaphragm and said voice coil, and includes a hinge part in proximity of the attaching counterpart, and
a housing part of adhesive material joining said vibration direction converter part and said attaching counterpart is formed on a surface side of said attaching counterpart facing said hinge part.

34. The speaker device according to claim 1, wherein
said vibration direction converter part includes a rigid link part angle-variably and obliquely disposed between said voice coil and said diaphragm, and a hinge part formed at both ends of said link part, and
said hinge part is formed with a bendable continuous member continuing between the parts of both sides over the hinge part.

35. The speaker device according to claim 1, wherein
said voice coil includes a planarly and annularly wound conducting member and a rigid base supporting said conducting member, and
a conducting layer is pattern formed at an outside face of said conducting member in said base.

36. The speaker device according to claim 34, wherein
a pair of said conducting layers is placed so as to enclose said conducting member and function as a junction wire for inputting an audio signal to said conducting member.

37. The speaker device according to claim 1, comprising a holding part, wherein said holding part holds said voice coil vibratably in said vibration direction of voice coil directly or via a separate member to said static part.

38-42. (canceled)
